(19) United States
(12) Patent Application Publication
(10) Pub. No.: US 2025/0202736 A1
(43) Pub. Date: Jun. 19, 2025

(54) COMMUNICATION APPARATUS AND COMMUNICATION METHOD FOR AGGREGATED SIGNAL SOUNDING PROCEDURE

(71) Applicant: Panasonic Intellectual Property Corporation of America, Torrance, CA (US)

(72) Inventors: Yanyi DING, Singapore (SG); Rojan CHITRAKAR, Singapore (SG); Yoshio URABE, Nara (JP); Hiroyuki MOTOZUKA, Kanagawa (JP)

(21) Appl. No.: 18/846,119

(22) PCT Filed: Feb. 28, 2023
(86) PCT No.: PCT/SG2023/050121

§ 371 Date: Sep. 11, 2024

(30) Foreign Application Priority Data
Mar. 16, 2022 (SG) 10202202676W

(51) Int. Cl. H04L 25/02; H04L 5/00

(52) U.S. Cl. CPC H04L 25/0226; H04L 5/0053; H04L 5/0094

(57) ABSTRACT

The present disclosure provides a communication apparatus comprising: circuitry, which, in operation, generates at least one signal, wherein a part of the at least one signal is configured for a first station of a first generation and another part of the at least one signal is configured for a second station of a second generation in a sounding procedure; and a transmitter, which, in operation, transmits the at least one signal.

### TECHNICAL FIELD

The present disclosure relates to communication apparatuses and methods for a sounding procedure, and more particularly for an aggregated signal sounding procedure in EHT WLAN (extremely high throughput wireless local area network).

### BACKGROUND

In the standardization of next generation wireless local area network (WLAN), a new radio access technology necessarily having backward compatibilities with IEEE 802.11a/b/g/n/ac/ax technologies has been discussed in the IEEE 802.11 Working Group and is named IEEE 802.11be Extremely High Throughput (EHT) WLAN.

In 802.11be EHT WLAN, in order to achieve good throughput gain with traffic from mixed generations of STAs in large bandwidth, it has been proposed to define aggregated physical layer protocol data unit (A-PPDU).

However, there is no sounding sequence defined for A-PPDU transmission. In particular, for a station (STA) with operating bandwidth (BW) smaller than the full basic service set (BSS) BW, participating in an A-PPDU and parking on a secondary channel, the sounding sequence according to the current specification is not applicable.

There is thus a need for communication apparatuses and methods that provide feasible technical solutions for aggregated signal sounding procedure in the context of EHT WLAN. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for aggregated signal sounding procedure in context of EHT WLAN.

In a first aspect, the present disclosure provides a communication apparatus comprising: circuitry, which, in operation, generates at least one signal, wherein a part of the at least one signal is configured for a first station of a first generation and another part of the at least one signal is configured for a second station of a second generation in a sounding procedure; and a transmitter, which, in operation, transmits the at least one signal.

In a second aspect, the present disclosure provides a communication method implemented by a communication apparatus comprising: generating at least one signal, wherein a part of the at least one signal is configured for a first station of a first generation and another part of the at least one signal is configured for a second station of a second generation in a sounding procedure; and transmitting the at least one signal.

In a third aspect, the present disclosure provides a first station comprising; a receiver, which, in operation, receive at least one signal, wherein a part of the at least one signal is configured for the first station of a first generation and another part of the at least one signal is configured for a second station of a second generation in a sounding procedure; and circuitry, which, in operation, decodes the at least one signal.

In a fourth aspect, the present disclosure provides a communication method implemented by a first station comprising: receiving at least one signal, wherein a part of the at least one signal is configured for the first station of a first generation and another part of the at least one signal is configured for a second station of a second generation in a sounding procedure; and decoding the at least one signal.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 depicts a schematic diagram of single-user (SU) communication between an access point (AP) and a station (STA) in a MIMO wireless network.

FIG. 2 depicts a schematic diagram of downlink multi-user (MU) communication between an AP and multiple STAs in a MIMO wireless network.

FIG. 3 depicts a schematic diagram of trigger-based uplink MU communication between an AP and multiple STAs in a MIMO wireless network.

FIG. 4 depicts a schematic diagram of trigger-based downlink multi-AP communication between multiple APs and a STA in a MIMO wireless network.

FIG. 5 depicts an aggregated physical layer protocol data unit (A-PPDU).

FIG. 6 depicts a flow chart illustrating a process of a STA participating in an A-PPDU transmission.

FIG. 7 depicts a flow diagram illustrating a High Efficiency (HE) trigger-based (TB) sounding procedure in 802.11ax.

FIG. 8 depicts a flow diagram illustrating an Extremely High Throughput (EHT) trigger-based (TB) sounding procedure in 802.11be.

FIG. 9 depicts signal fields in an EHT sounding null data packet (NDP) of FIG. 8.

FIG. 10 depicts a format of an HE NDP Announcement (NDPA) frame.

FIG. 11 depicts a format of an EHT NDPA frame.

FIG. 12 depicts a tone plan and RU locations for an HE 80 MHz PPDUs, respectively.

FIG. 13 depicts a tone plan and resource unit (RU) locations for an EHT 80 MHz PPDUs, respectively.

FIG. 14 depicts an HE Sounding NDP and an EHT Sounding NDP.

FIG. 15 depicts a flow diagram illustrating communications between an AP and EHT STAs parking on the primary channels and EHT STAs parking the secondary channels.

FIG. 16 depicts a flow diagram illustrating a conventional sounding procedure for HE STAs parking on the primary 80 MHz or 160 MHz channel and EHT STAs parking on the secondary channel prior to an A-PPDU transmission.

FIG. 17 depicts a flow diagram illustrating an aggregated TB sounding procedure for HE STAs and EHT STAs according to various embodiments of the present disclosure.

FIG. 18 depicts a schematic, partially sectioned view of a communication apparatus according to the present disclosure.

FIG. 19 shows a flow diagram illustrating a communication method implemented by an AP according to various embodiments of the present disclosure.

FIG. 20 shows a flow diagram illustrating a communication method implemented by a STA of a generation according to various embodiments of the present disclosure.

FIG. 21 depicts a flow diagram illustrating an example A-PPDU sounding procedure according to a first embodiment of the present disclosure.

FIG. 22 depicts a flow diagram illustrating an example A-PPDU sounding procedure according to a second embodiment of the present disclosure.

FIG. 23 depicts an example format of a downlink (DL) PPDU carrying multiple HE NDP Announcement frames according to an embodiment of the present disclosure.

FIG. 24 depicts an example format of a DL PPDU carrying multiple Beamforming Report Poll (BFRP) Trigger frames (TF) according to an embodiment of the present disclosure.

FIG. 25 depicts a flow diagram illustrating an example A-PPDU sounding procedure according to a third embodiment of the present disclosure.

FIG. 26 depicts an example format of a DL PPDU carrying multiple HE NDP Announcement frames according to an embodiment of the present disclosure.

FIG. 27 depicts an example format of an HE NDP Announcement frame according to an embodiment of the present disclosure.

FIG. 28 depicts an example format of a DL PPDU carrying an EHT BFRP TF and an HE BFRP TF according to an embodiment of the present disclosure.

FIG. 29 depicts a flow diagram illustrating an example A-PPDU sounding procedure according to a fourth embodiment of the present disclosure.

FIG. 30 depicts an example format of a DL PPDU carrying the HE and EHT NDP Announcement frames according to an embodiment of the present disclosure.

FIG. 31 depicts an example format of an EHT NDP Announcement frame according to an embodiment of the present disclosure.

FIG. 32 depicts an example format of a DL PPDU 2916 carrying an EHT BFRP TF and an HE BFRP TF according to an embodiment of the present disclosure.

FIG. 33 depicts a flow diagram 3300 illustrating an example A-PPDU sounding procedure according to a fifth embodiment of the present disclosure.

FIG. 34 depicts a first example format of a special EHT Sounding NDP according to an embodiment of the present disclosure.

FIG. 35 depicts a second example format of a special EHT Sounding NDP according to an embodiment of the present disclosure.

FIG. 36 depicts a flow diagram illustrating an example A-PPDU sounding procedure according to a sixth embodiment of the present disclosure.

FIG. 37 depict an example HE Sounding NDP and an example EHT Sounding NDP which are not orthogonally aligned but are transmitted simultaneously in an aggregated trigger-based sounding procedure according to an embodiment of the present disclosure.

FIG. 38 depicts a block diagram illustrating an OFDMA transmission with multiple IFFT processors according to an embodiment of the present disclosure.

FIG. 39 depicts a flow diagram illustrating an example A-PPDU sounding procedure in a multi-link (Link 1, Link 2) system according to an embodiment of the present disclosure.

FIG. 40 depicts a flow diagram illustrating an example A-PPDU sounding procedure using full bandwidth special HE Sounding NDP 4014 according to an embodiment of the present disclosure.

FIG. 41 depicts a configuration of a communication apparatus, for example an AP, according to various embodiments of the present disclosure.

FIG. 42 depicts a configuration of a communication apparatus, for example a STA, according to various embodiments of the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help an accurate understanding of the present embodiments.

### DETAILED DESCRIPTION

Some embodiments of the present disclosure will be described, by way of example only, with reference to the drawings. Like reference numerals and characters in the drawings refer to like elements or equivalents.

In the following paragraphs, certain exemplifying embodiments are explained with reference to an access point (AP) and a station (STA) for an aggregated signal sounding procedure, especially in a multiple-input multiple-output (MIMO) wireless network.

In the context of IEEE 802.11 (Wi-Fi) technologies, a station, which is interchangeably referred to as a STA, is a communication apparatus that has the capability to use the 802.11 protocol. Based on the IEEE 802.11-2016 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point or a Wi-Fi phone in a wireless local area network (WLAN) environment. The STA may be fixed or mobile. In the WLAN environment, the terms “STA”, “wireless client”, “user”, “user device”, and “node” are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at a different occasion, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

In a MIMO wireless network, “multiple” refers to multiple antennas used simultaneously for transmission and multiple antennas used simultaneously for reception, over a radio channel. In this regard, “multiple-input” refers to multiple transmitter antennas, which input a radio signal into the channel, and “multiple-output” refers to multiple receiver antennas, which receive the radio signal from the channel and into the receiver. For example, in an N×M MIMO network system, N is the number of transmitter antennas, M is the number of receiver antennas, and N may or may not be equal to M. For the sake of simplicity, the respective numbers of transmitter antennas and receiver antennas are not discussed further in the present disclosure.

In a MIMO wireless network, single-user (SU) communications and multi-user (MU) communications can be deployed for communications between communication apparatuses such as APs and STAs. MIMO wireless network has benefits like spatial multiplexing and spatial diversity, which enable higher data rates and robustness through the use of multiple spatial streams. According to various embodiments, the term “spatial stream” may be used interchangeably with the term “space-time stream” (or STS).

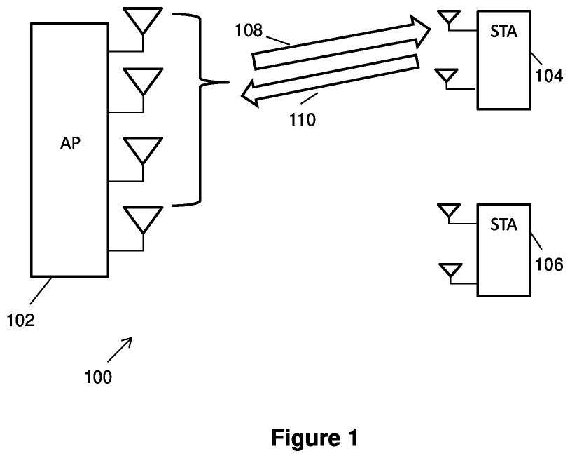

FIG. 1 depicts a schematic diagram of SU communication 100 between an AP 102 and a STA 104 in a MIMO wireless network. As shown, the MIMO wireless network may include one or more STAs (e.g. STA 104, STA 106, etc.). If the SU communication 100 in a channel is carried out over whole channel bandwidth, it is called full bandwidth SU communication. If the SU communication 100 in a channel is carried out over a part of the channel bandwidth (e.g. one or more 20 MHz subchannels within the channel is punctured), it is called punctured SU communication. In the SU communication 100, the AP 102 transmits multiple space-time streams using multiple antennas (e.g. four antennas as shown in FIG. 1) with all the space-time streams directed to a single communication apparatus, i.e. the STA 104. For the sake of simplicity, the multiple space-time streams directed to the STA 104 are illustrated as a grouped data transmission arrow 108 directed to the STA 104.

The SU communication 100 can be configured for bi-directional transmissions. As shown in FIG. 1, in the SU communication 100, the STA 104 may transmit multiple space-time streams using multiple antennas (e.g. two antennas as shown in FIG. 1) with all the space-time streams directed to the AP 102. For the sake of simplicity, the multiple space-time streams directed to the AP 102 are illustrated as a grouped data transmission arrow 110 directed to the AP 102.

As such, the SU communication 100 depicted in FIG. 1 enables both uplink and downlink SU transmissions in a MIMO wireless network.

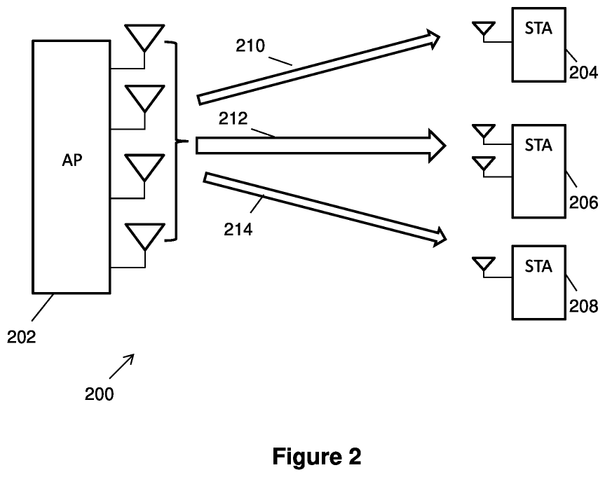

FIG. 2 depicts a schematic diagram of downlink MU communication 200 between an AP 202 and multiple STAs 204, 206, 208 in a MIMO wireless network. The MIMO wireless network may include one or more STAs (e.g. STA 204, STA 206, STA 208, etc.). The MU communication 200 can be an OFDMA (orthogonal frequency division multiple access) communications or a MU-MIMO communication. For an OFDMA communication in a channel, the AP 202 transmits multiple streams simultaneously to the STAs 204, 206, 208 in the network at different resource units (RUs) within the channel bandwidth. For a MU-MIMO communication in a channel, the AP 202 transmits multiple streams simultaneously to the STAs 204, 206, 208 at same RU(s) within the channel bandwidth using multiple antennas via spatial mapping or precoding techniques. If the RU(s) at which the OFDMA or MU-MIMO communication occurs occupy whole channel bandwidth, the OFDMA or MU-MIMO communications is called full bandwidth OFDMA or MU-MIMO communications. If the RU(s) at which the OFDMA or MU-MIMO communication occurs occupy a part of channel bandwidth (e.g. one or more 20 MHz subchannel within the channel is punctured), the OFDMA or MU-MIMO communication is called punctured OFDMA or MU-MIMO communications.

For example, two space-time streams may be directed to the STA 206, another space-time stream may be directed to the STA 204, and yet another space-time stream may be directed to the STA 208. For the sake of simplicity, the two space-time streams directed to the STA 206 are illustrated as a grouped data transmission arrow 212, the space-time stream directed to the STA 204 is illustrated as a data transmission arrow 210, and the space-time stream directed to the STA 208 is illustrated as a data transmission arrow 214.

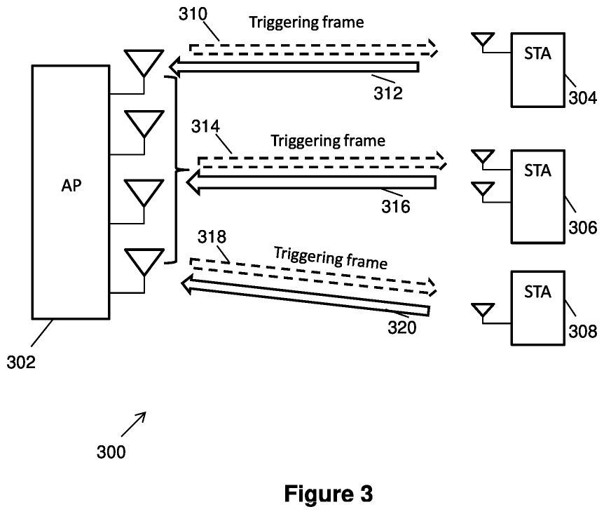

To enable uplink MU transmissions, trigger-based communication is provided to the MIMO wireless network. In this regard, FIG. 3 depicts a schematic diagram of trigger-based uplink MU communication 300 between an AP 302 and multiple STAs 304, 306, 308 in a MIMO wireless network.

Since there are multiple STAs 304, 306, 308 participating in the trigger-based uplink MU communication, the AP 302 needs to coordinate simultaneous transmissions of multiple STAs 304, 306, 308.

To do so, as shown in FIG. 3, the AP 302 transmits triggering frames 310, 314, 318 simultaneously to STAs 304, 306, 308 to indicate user-specific resource allocation information (e.g. the number of space-time streams, a starting STS number and the allocated RUs) each STA can use. In response to the triggering frames, STAs 304, 306, 308 may then transmit their respective space-time streams simultaneously to the AP 302 according to the user-specific resource allocation information indicated in the triggering frames 310, 314, 318. For example, two space-time streams may be directed to the AP 302 from STA 306, another space-time stream may be directed to the AP 302 from STA 304, and yet another space-time stream may be directed to the AP 302 from STA 308. For the sake of simplicity, the two space-time streams directed to the AP 302 from STA 306 are illustrated as a grouped data transmission arrow 316, the space-time stream directed to the AP 302 from STA 304 is illustrated as a data transmission arrow 312, and the space-time stream directed to the AP 302 from STA 308 is illustrated as a data transmission arrow 320.

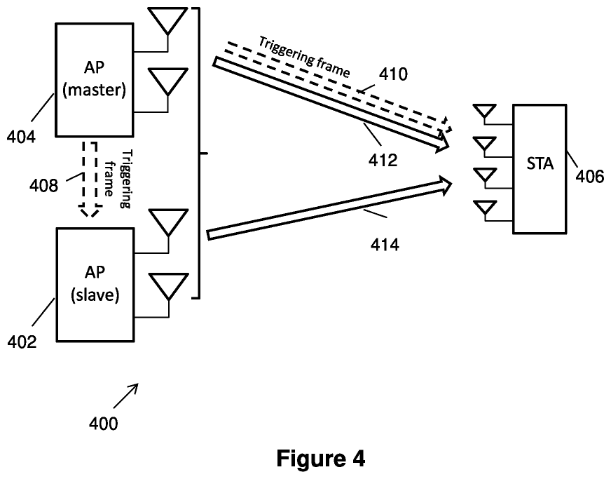

Trigger-based communication is also provided to the MIMO wireless network to enable downlink multi-AP communication. In this regard, FIG. 4 depicts a schematic diagram of downlink multi-AP communication 400, between a STA 406 and multiple APs 402, 404 in a MIMO wireless network.

Since there are multiple APs 402, 404 participating in the trigger-based downlink multi-AP MIMO communication, the master AP 404 needs to coordinate simultaneous transmissions of multiple APs 402, 404.

To do so, as shown in FIG. 4, the master AP 404 transmits triggering frames 408, 410 simultaneously to the AP 402 and the STA 406 to indicate AP-specific resource allocation information (e.g. the number of space-time streams, a starting STS stream number and the allocated RUs) each AP can use. In response to the triggering frames, the multiple APs 402, 404 may then transmit respective space-time streams to the STA 406 according to the AP-specific resource allocation information indicated in the triggering frame 408; and the STA 406 may then receive all the space-time streams according to the AP-specific resource allocation information indicated in the triggering frame 410. For example, two space-time streams may be directed to the STA 406 from AP 404, and another two space-time streams may be directed to the STA 406 from AP 402. For the sake of simplicity, the two space-time streams directed to the STA 406 from AP 404 are illustrated as a grouped data transmission arrow 412, and the two space-time streams directed to the STA 406 from the AP 402 is illustrated as a grouped data transmission arrow 414.

Due to packet/PPDU (physical layer protocol data unit) based transmission and distributed MAC (medium access control) scheme in 802.11 WLAN, time scheduling (e.g. TDMA (time division multiple access)-like periodic time slot assignment for data transmission) does not exist in 802.11 WLAN. Frequency and spatial resource scheduling is performed on a packet basis. In other words, resource allocation information is on a PPDU basis.

According to various embodiments, EHT WLAN supports non-trigger-based communications as illustrated in FIGS. 1 and 2 and trigger-based communications as illustrated in FIGS. 3 and 4. In non-trigger-based communications, a communication apparatus transmits a PPDU to one other communication apparatus or more than one other communication apparatuses in an unsolicited manner. In trigger-based communications, a communication apparatus transmits a PPDU to one other communication apparatus or more than one other communication apparatuses only after a soliciting triggering frame is received.

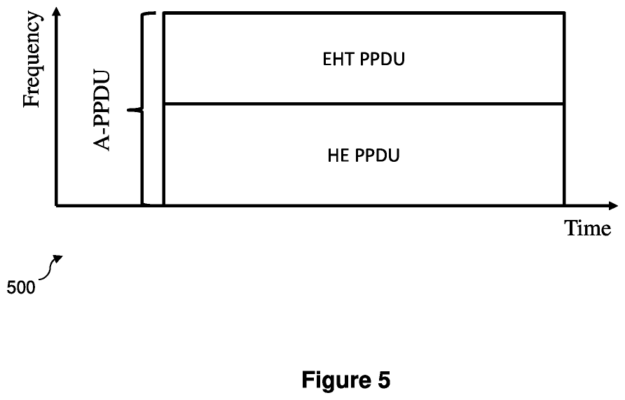

FIG. 5 depicts an example of a format of an aggregated physical layer protocol data unit (A-PPDU) 500. Different amendments of PPDUs in an A-PPDU 500 may include High Efficiency (HE) PPDU and Extremely High Throughput (EHT) PPDU and the PPDUs consisted in the PPDU are orthogonal in frequency domain symbol-by-symbol. PPDUs may be transmitted to multiple STAs (e.g. STAs 204, 206) simultaneously. Each STA may support different amendment (e.g. 11ax, 11be,) in other words, each STA may have different capability. For example, STA 204 may be an HE STA (i.e. a STA supports 802.11ax amendment) and STA 206 may be an EHT STA (i.e. a STA supports 802.11be amendment,) and the HE PPDU is directed to HE STA 204 and the EHT PPDU is directed to EHT STA 206. The bandwidth of a single PPDU of an A-PPDU may be equal to or larger than 80 MHz. One of the PPDU (e.g. HE PPDU in FIG. 5) may occupy the primary channel (e.g. Primary 80 MHZ (P80) channel,) and the other PPDU (e.g. EHT PPDU in FIG. 5) may occupy the secondary (non-primary) channel (e.g. Secondary 80 MHZ (S80) channel). Subchannel selective transmission (SST) scheme may be used to set up PPDU transmission over secondary 80/160 MHz channel prior to the A-PPDU transmission.

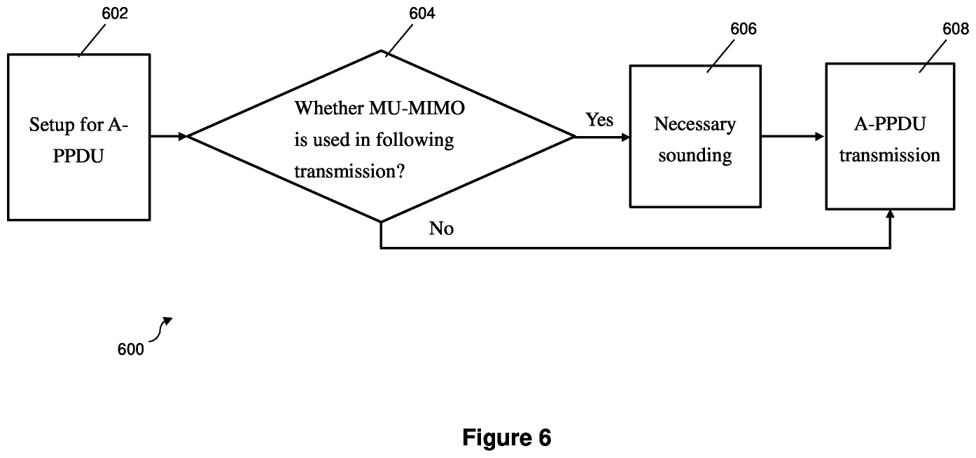

FIG. 6 depicts a flow chart 600 illustrating a process of a STA participating in an A-PPDU transmission. In step 602, a setup for A-PPDU is carried out which includes, but not limited to, the following steps such as capabilities negotiation, SST setup and frequency segment allocation. In step 604, it is then determined whether MU-MIMO is used in following transmissions. If no MU-MIMO is used in subsequent transmissions, step 608 is carried out and the A-PPDU transmission is carried out. When MU-MIMO is used in subsequent transmissions, a sounding procedure is needed and therefore step 606 is carried out where necessary sounding is carried out. The A-PPDU transmission in step 608 may be either uplink (UL) or downlink (DL). It is noted that steps 602-608 may cover more than one transmission opportunity (TXOP).

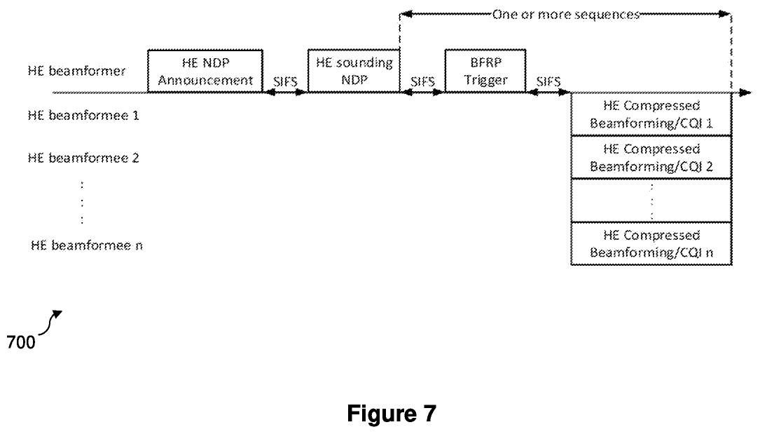

In 802.11, in order to determine the weights of beamforming, sounding procedure is needed prior to a transmission. FIG. 7 depicts a flow diagram 700 illustrating an HE trigger-based (TB) sounding procedure in 802.11ax. An HE beamformer (AP) transmits an HE Null Data Packet (NDP) Announcement (NDPA) frame, an HE sounding NDP after a short interframe spacing (SIFS). After another SIFS, the HE beamformer transmits a Beamforming Report Poll (BFRP) Trigger frame to the HE beamformers 1-n (STAs) to solicit a feedback from each of the HE beamformers. After yet another SIFs, each HE beamformer then responds to the Trigger frame by transmitting an HE Compressed Beamforming (CBR)/channel quality indicator (CQI) frame. Although the communication of the trigger frame and the feedback between the HE beamformer and all the beamformees in one sequence is illustrated, the communication between the HE beamformer and all the beamformees may be carried out in more than one sequence. It is noted that the HE sounding NDP supports sounding in bandwidth up to 160 MHz.

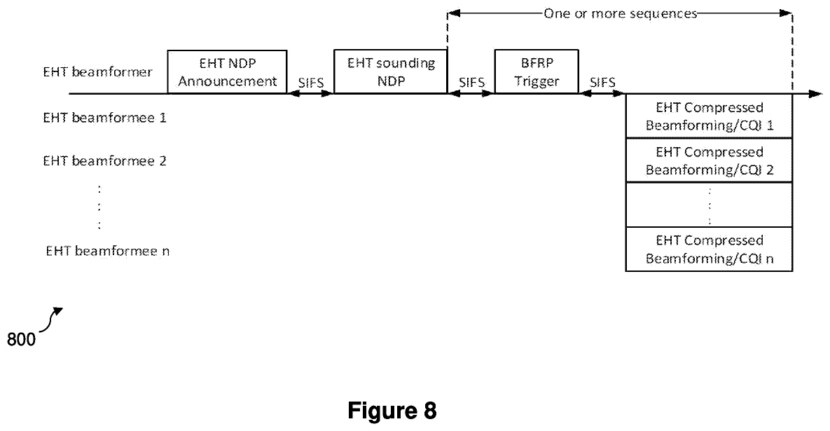

FIG. 8 depicts a flow diagram 800 illustrating an EHT trigger-based (TB) sounding procedure in 802.11be. An EHT beamformer (AP) transmits an EHT NDPA frame, an EHT sounding NDP after a SIFS. After another SIFS, the EHT beamformer transmits a Beamforming Report Poll (BFRP) Trigger frame to the EHT beamformees 1-n (STAs) to solicit a feedback from each of the EHT beamformees. After yet another SIFS, Each EHT beamformee then responds to the Trigger frame by transmitting an EHT Compressed Beamforming/CQI frame. Although the communication of the trigger frame and the feedback between the EHT beamformer and all the beamformees in one sequence is illustrated, the communication between the EHT beamformer and all the beamformees may be carried out in more than one sequence.

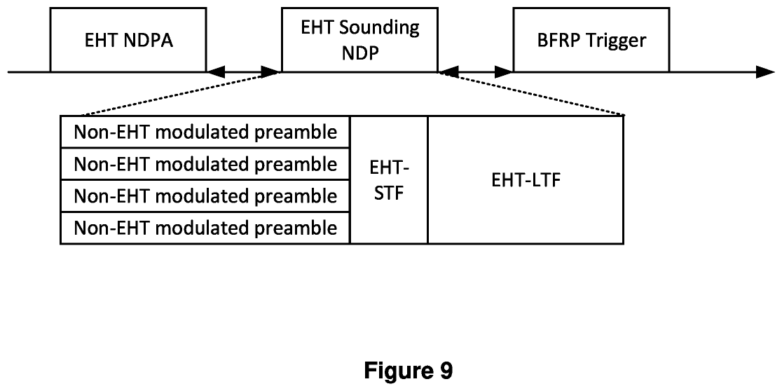

In EHT, the MU sounding is defined to mixed bandwidth STAs, the bandwidth of EHT Sounding NDP may exceed the minimal operating bandwidth of receiver STAs. FIG. 9 depicts signal fields in an EHT sounding NDP of FIG. 8. The EHT Sounding NDP comprises non-EHT modulated preamble(s) which are orthogonal in frequency domain (i.e., each transmitted in partial bandwidth), an EHT-Short Training Field (STF) and EHT-Long Training Field (LTF). The EHT-STF EHT-LTF are transmitted in full bandwidth. The EHT-LTF is used to calculated channel information.

It is noted that the beamformee support of receiving NDP with bandwidth (BW) wider than the STA's operating BW is mandatory for STAs with operating BW is 80 MHz or larger, but is optional for STAs with operating BW is 20 MHz.

It is further noted that the differences between HE and EHT sounding sequence include: (a) the signaling in HE NDP Announcement frame and EHT NDP Announcement frame; (b) the tone plan in HE PPDU and EHT PPDU; and (c) the format of HE Sounding NDP and EHT Sounding NDP. More details will be elaborated in the following paragraphs.

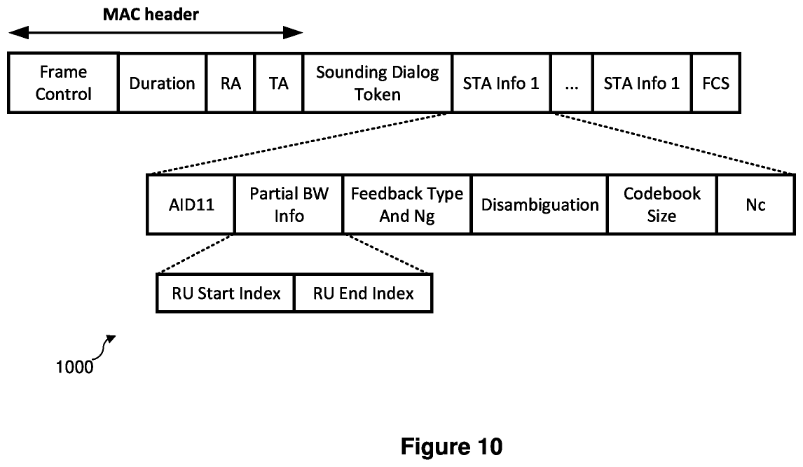

FIG. 10 depicts a format of an HE NDPA frame 1000. The HE NDPA frame 1000 includes (or consists of) a Frame Control field, a Duration field, a Recipient Address (RA) field, a Transmitter Address (TA) field, a Sounding Dialog Token field, one or more STA Info fields and a FCS (frame check sequence) field. The Frame Control field, the Duration field, the RA field and the TA field may be grouped as MAC header. Each STA Info field includes (or consists of) an AID11 field, a Partial BW Info field, a Feedback Type And Ng field, a Disambiguation field, a Codebook Size field and a Number of Column (Nc) field. The Partial BW Info field may include (or consist of) a RU Start Index field and a RU End Index field which indicate the first and last 26-tone RU between which the HE beamformer is requesting feedback. Upon receipt of the HE NDPA frame 1000, a beamformee prepares feedback according to subcarriers indicated by the Partial BW Info field following the HE tone plan specified in the 802.11 specification.

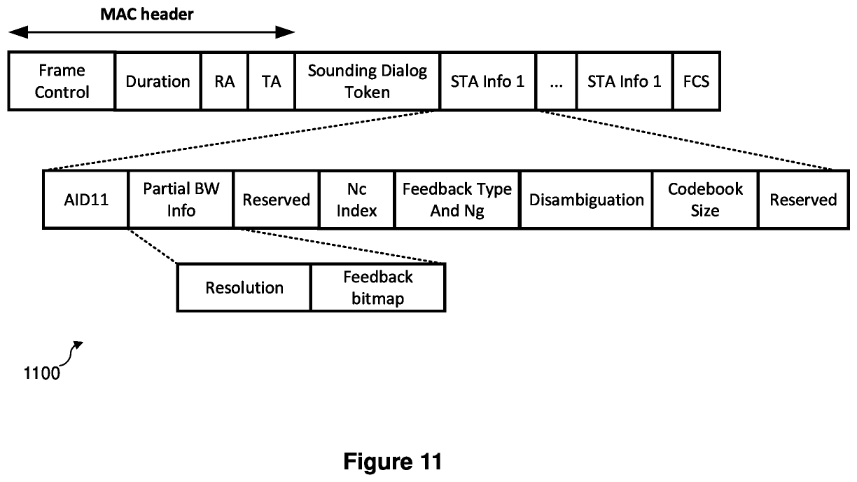

FIG. 11 depicts a format of an EHT NDPA frame 1100. The EHT NDPA frame 1100 includes (or consist of) a Frame Control field, a Duration field, a RA field, a TA field, a Sounding Dialog Token field, one or more STA Info fields and a FCS field. The Frame Control field, the Duration field, the RA field and the TA field may be grouped as MAC header. Each STA Info field includes (or consists of) an AID11 field, a Partial BW Info field, a Nc index field, a Feedback Type And Ng field, a Disambiguation field, a Codebook Size field and a Nc field. The Partial BW Info field may further include (or consist of) a Resolution field and a Feedback Bitmap field which respectively indicate the resolution bandwidth for each bit in the bitmap (20 MHz/40 MHZ)) and the subchannel(s) for which the EHT beamformer is requesting feedback. Upon receipt of the EHT NDPA frame 1100, a beamformee prepares feedback according to subcarriers indicated by the Partial BW Info field following the EHT tone plan specified in the 802.11 specification

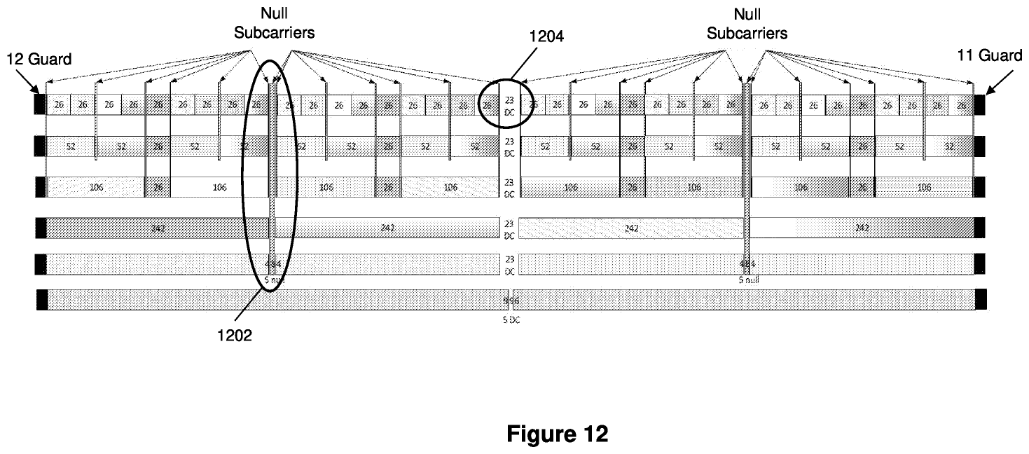

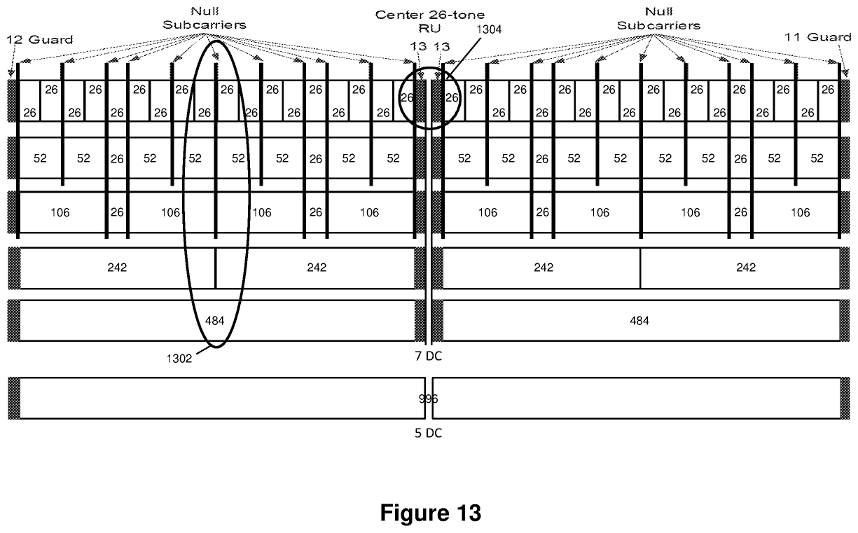

The EHT tone plan and RU locations for PPDU larger than 40 MHz are different from those of HE PHY. FIGS. 12 and 13 depict tone plans and RU locations for EHT and HE 80 MHz PPDUs, respectively. The differences between the EHT and HE tone plans and RU locations are indicated in circles 1202, 1204, 1302, 1304. It is noted that the EHT and HE tone plans for 160/320 MHz PPDU is simple duplication of tone plane for 80 MHz. In particular, in HE and EHT PPDU, different tone plans lead to different subcarrier range referred by the same RU index. For example, in 80 MHz HE and EHT PPDUs, if a 26-tone RU with RU index 28 is indicated, the subcarrier range in HE and EHT PPDU are different.

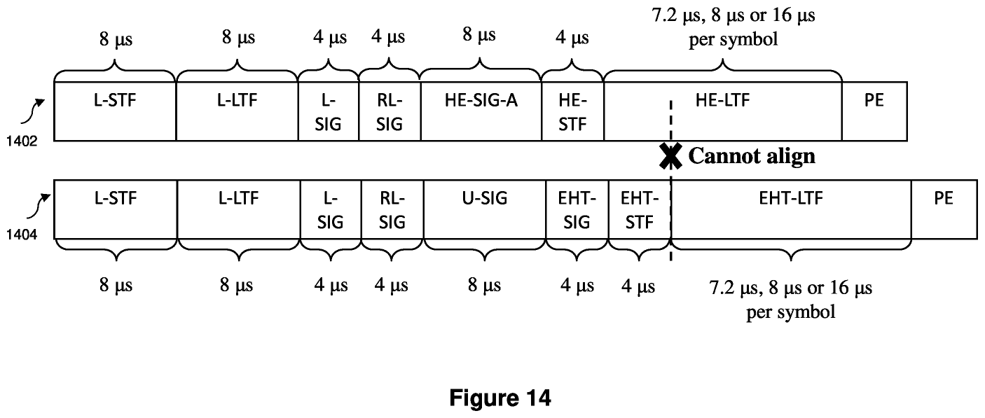

In addition, the HE Sounding NDP and EHT Sounding NDP cannot be aligned in time domain. FIG. 14 depicts an HE Sounding NDP 1402 and an EHT Sounding NDP 1404. The HE Sounding NDP 1402 include or consist of a L-STF, a L-LTF, a L-SIG (signal) field, a RL-SI (signal) field, an HE-SIG-A field, an HE-STF field, an HE-LTF field and a Packet Extension (PE) field. The guard intervals (GIs) of the L-STF, L-LTF, L-SIG field, RL-SIG field, HE-SIG-A field, HE-STF are 8 μs, 8 μs, 4 μs, 4 μs, 8 μs and 4 μs respectively, while the HE-LTF comprises one or more HE-LTF symbols with 7.2 μs, 8 μs or 16 μs per symbol. The EHT Sounding NDP 1404 include or consist of a L-STF, a L-LTF, a L-SIG field, a RL-SI field, a U-SIG field, an EHT-SIG field, an EHT-STF field, an EHT-LTF field and a PE field. The guard intervals (GIs) of the L-STF, L-LTF, L-SIG field, RL-SIG field, U-SIG field, EHT-SIG field, EHT-STF are 8 μs, 8 μs, 4 μs, 4 μs, 8 μs, 4 μs, 4 μs respectively, while the EHT-LTF comprises one or more EHT-LTF symbols with 7.2 μs, 8 μs or 16 μs per symbol. The L-STF, L-LTF, L-SIG field, RL-SIG field, HE-SIG-A field and HE-STF of the HE Sounding NDP 1402 may align with the L-STF, L-LTF, L-SIG field, RL-SIG field, U-SIG field and EHT-SIG field in time domain, however, due to the additional EHT-SIG field, an unalignment between the HE and EHT Sounding NDPs may occur, as illustrated in FIG. 14.

Table 1 illustrates RU indices and their corresponding indications on whether subcarrier range between 80 MHz HE and EHT PPDUs is same or different.

TABLE 1

| | RU index referred to same | RU index referred to |
|---|---|---|
| | subcarrier range between | different subcarrier range |
| RU size | HE and EHT PPDUs | between HE and EHT PPDUs |
| 26-tone | RU 1~RU 9 | RU 10~RU 37 |
| 52-tone | RU 1~RU 4 | RU 5~RU 16 |
| 106-tone | RU 1~RU 2 | RU 3~RU 8 |
| 242-tone | RU 1 | RU 2~RU 4 |
| 484-tone | RU 1 | RU 2 |
| 996-tone | RU 1 | — |

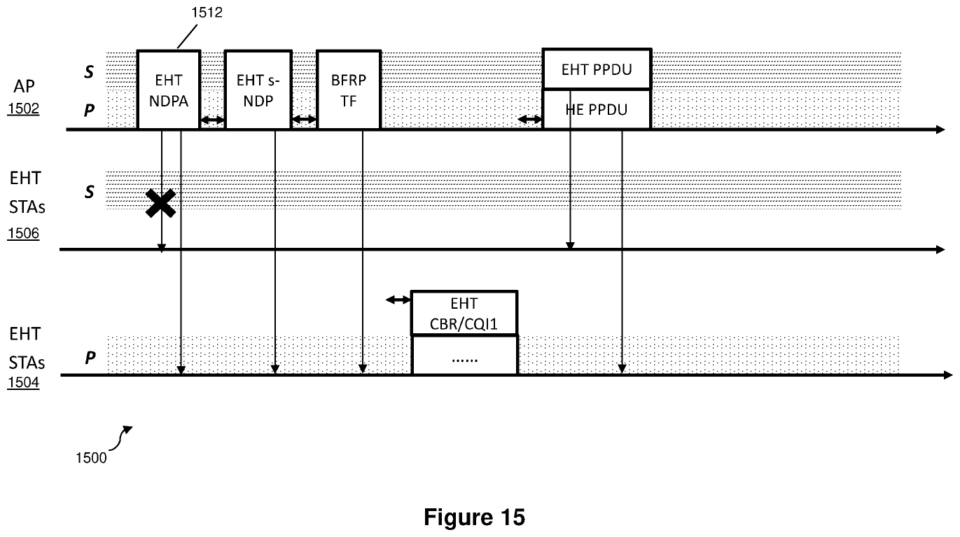

According to 802.11be and current specification, for a non-AP STA with operating BW smaller than the full basic service set (BSS) BW, participating in an A-PPDU and parking on a secondary channel, the sounding sequence is not applicable. Currently, all PPDU transmission shall not overlap with the primary channel and the non-AP STAs parking on the non-primary channel will reject wider bandwidth PPDU. FIG. 15 depicts a flow diagram 1500 illustrating communications between an AP 1502 and EHT STAs 1504 parking on the primary channels and EHT STAs 1506 parking the secondary channels. An EHT NDPA frame 1512 is transmitted in the full bandwidth (primary channel+secondary channel) to EHT STAs 1504 parking on the primary channels and EHT STAs 1506 parking the secondary channels, the EHT STAs 1506 do not recognize the EHT NDPA frame 1512 and therefore reject the EHT NDPA frame 1512. This may cause issue in the communications between the AP 1502 and EHT STAs 1506 parking on the secondary channel in the absence of sounding. Therefore, a sounding solution for non-AP STAs with operating BW smaller than the full BSS BW and parking on the non-primary channel is needed.

Conventionally, a design for EHT Sounding NDP without EHT-SIG field was proposed to eliminate the unalignment between the EHT Sounding NDP and HE Sounding NDP. It was further proposed to use NDPA frame or Compression Mode bit to indicate EHT Sounding NDP format. However, this raises a concern to keep the NDP format unified as the NDP is a special case of SU transmission (e.g., EHT-SIG field exits in PPDU of SU transmission). Another concern that the implicit indication of NDP format using NDPA frame isn't safe enough and explicit indication of Compression Mode is too late for automatic gain control (AGC) setting is also raised.

As mentioned above, prior to an A-PPDU transmission (HE STAs and part of EHT STAs park on the primary channel, while other EHT STAs park on the second channel), a trigger-based (TB) sounding procedure for HE STAs and EHT STAs is needed. However, according to 802.11be and current specification, a trigger-based (TB) sounding procedure can only be carried out separately.

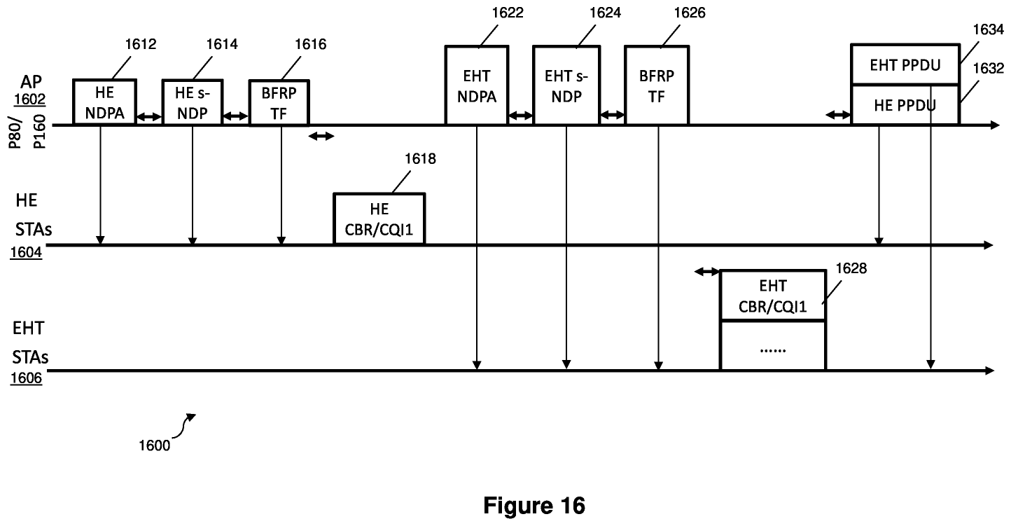

FIG. 16 depicts a flow diagram 1600 illustrating a conventional sounding procedure for HE STAs 1604 parking on the primary 80 MHz or 160 MHz channel and EHT STAs 1606 parking on the secondary channel prior to an A-PPDU transmission. An AP 1602 first transmits an HE NDPA frame 1612, HE Sounding NDP 1614 and a BFRP Trigger frame (TF) 1616 to the HE STAs to the HE STAs 1604 to solicit a feedback and, after a SIFS, the HE STAs 1604 transmit HE CBR/CQI frame 1618 containing the feedback to the AP 1602. Subsequently, the AP 1604 transmits an EHT NDPA frame 1622, an EHT Sounding NDP 1624 and a BFRP trigger frame 1626 to the EHT STAs 1604 to solicit a feedback, and, after a SIFS, the EHT STAs 1604 transmit EHT CBR/CQI frame 1628 containing the feedback to the AP 1602. Next, after a SIFS, the AP 1602 then perform A-PPDU transmissions to transmit HE PPDU 1632 and EHT PPDU 1634 to the HE STAs 1604 and EHT STAs 1606 respectively. Two rounds of TB sounding procedure are required which bring a large overhead to the procedure, therefore a more efficient sounding procedure is needed.

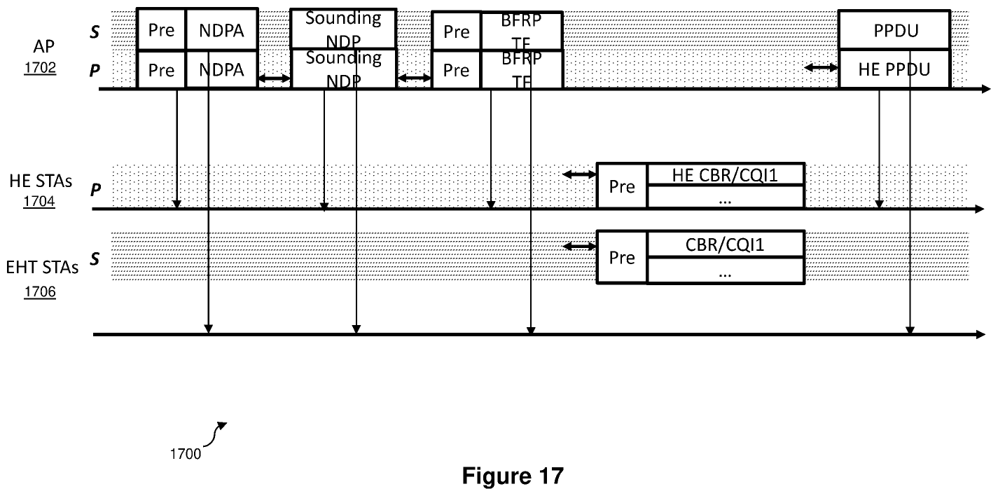

According to various embodiments of the present disclosure, prior to a synchronous transmission that contains multiple PPDUs, an aggregated trigger-based (TB) sounding procedure is carried out, allowing TB sounding procedures for STAs of different generations (e.g., HE and EHT STAs) to be carried out simultaneously. FIG. 17 depicts a flow diagram 1700 illustrating an aggregated TB sounding procedure for HE STAs 1704 and EHT STAs 1706 according to various embodiments of the present disclosure. The HE STAs 1704 park on the primary channel (P) while the EHT STAs 1706 park on the secondary channel(S). The aggregated TB Sounding sequence according to various embodiments of the present disclosure is initiated when the AP 1702 generates and transmits a DL PPDU that carries more than one NDPA frame, in this case, one on the primary channel and another one on the secondary channel. The type of NDPA frames can be different from the type of the transmission following the sounding procedure. After a SIFS, the AP 1702 then generates and transmits an aggregated Sounding NDP to STAs of different generations simultaneously, in this case, to the HE STAs 1704 on the primary channel and to the EHT STAs 1706 on the secondary channel. The type of Sounding NDP can be different from the type of the transmission following the sounding procedure. After a SIFS, the AP 1702 generates and transmits BFRP trigger frames to solicit Beamforming Report feedback from STAs of different generations simultaneously, in this case, to the HE STAs 1704 on the primary channel and to the EHT STAs 1706 on the secondary channel. After a SIFS, the solicited STAs respond with TB PPDUs containing Beamforming Report feedback simultaneously. The type of Beamforming Report feedback NDP can be different from the type of transmission following the sounding procedure. This is assumed that SST is supported in the BSS, only 80/160/320 MHz operating non-AP STA can operate on non-primary 80/160 MHz channel. Advantageously, this can save 50% overhead as compared to the sequential scheme as described above in FIG. 16.

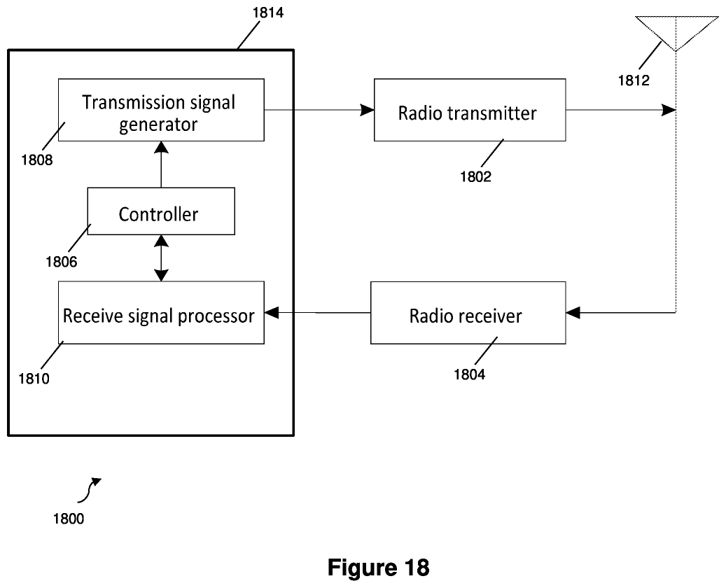

FIG. 18 depicts a schematic, partially sectioned view of a communication apparatus 1800 according to the present disclosure. The communication apparatus 1800 may also be implemented as an AP or a STA.

As shown in FIG. 18, the communication apparatus 1800 may include circuitry 1814, at least one radio transmitter 1802, at least one radio receiver 1804, and at least one antenna 1812 (for the sake of simplicity, only one antenna is depicted in FIG. 18 for illustration purposes). The circuitry 1814 may include at least one controller 1803 for use in software and hardware aided execution of tasks that the at least one controller 1806 is designed to perform, including control of communications with one or more other communication apparatuses in a MIMO wireless network. The circuitry 1814 may furthermore include at least one transmission signal generator 1808 and at least one receive signal processor 1810. The at least one controller 1806 may control the at least one transmission signal generator 1808 for generating MAC frames (for example NDP Announcement (NDPA) frame, Sounding NDP, Beamforming Report Poll (BFRP) Trigger frame, compressed beamforming (CBR)/channel quality indicator (CQI) frame) and PPDUs (for example PPDUs used for non-trigger-based communications or PPDUs used for trigger-based sounding procedure, or PPDUs used for trigger-based downlink transmissions if the communication apparatus 1800 is an AP, and for example or PPDUs used for trigger-based uplink transmissions if the communication apparatus 1800 is a STA) to be sent through the at least one radio transmitter 1802 to one or more other communication apparatuses and the at least one receive signal processor 1810 for processing MAC frames (for example NDP Announcement (NDPA) frame, Sounding NDP, Beamforming Report Poll (BFRP) Trigger frame, compressed beamforming (CBR)/channel quality indicator (CQI) frame) and PPDUs (for example PPDUs used for non-trigger-based communications or PPDUs used for trigger-based sounding procedure, or PPDUs used for trigger-based uplink transmissions if the communication apparatus 1800 is an AP, and for example or PPDUs used for trigger-based downlink transmissions if the communication apparatus 1800 is a STA) received through the at least one radio receiver 1804 from the one or more other communication apparatuses under the control of the at least one controller 1806. The at least one transmission signal generator 1808 and the at least one receive signal processor 1810 may be stand-alone modules of the communication apparatus 1800 that communicate with the at least one controller 1806 for the above-mentioned functions, as shown in FIG. 18. Alternatively, the at least one transmission signal generator 1808 and the at least one receive signal processor 1810 may be included in the at least one controller 1806. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 1802, at least one radio receiver 1804, and at least one antenna 1812 may be controlled by the at least one controller 1806.

The communication apparatus 1800, when in operation, provides functions required for A-PPDU sounding procedure. For example, the communication apparatus 1800 may be an AP, and the circuitry 1814 (for example the at least one transmission signal generator 1808 of the circuitry 1814) may, in operation, generate at least one signal, wherein a part of the at least one signal is configured for a first STA of a first generation (e.g., HE STA) and another part of the at least one signal is configured for a second station of a second generation (e.g., EHT STA) in a sounding procedure. The radio transmitter 1802 may in operation, transmits the at least one signal. In one embodiment, at least a part of the at least one signal includes information for the second STA and the first STA does not recognize the information. In another embodiment, the at least one signal that the circuitry 1814 generates and the at least one radio transmitter 1802 transmits comprises three different signals which are a NDPA frame indicating a sounding sequence of the sounding procedure, a Sounding NDP carrying a field for channel estimation and a Trigger frame carrying information to solicit a response signal from the first STA and the second STA.

The communication apparatus 1800 may be a STA of a generation (e.g., HE STA or EHT STA), and the at least one radio receiver 1804 may, in operation, receive at least one signal, wherein a part of the at least one signal is configured for the STA of the generation and another part of the at least one signal is configured for another STA of another generation in a sounding procedure, and the circuitry 1814 (for example the at least one receive signal processor 1810 of the circuitry 1814) may, in operation, decode the at least one signal. In one embodiment, at least a part of the at least one signal includes information for the other STA and the STA does not recognize the information. In another embodiment, the at least one signal that the at least one radio receiver 1804 receives and the circuitry (for example the at least one receive signal processor 1810 of the circuitry 1814) decodes comprises three different signals which are a NDPA frame indicating a sounding sequence of the sounding procedure, a Sounding NDP carrying a field for channel estimation and a Trigger frame carrying information to solicit a response signal from the STA.

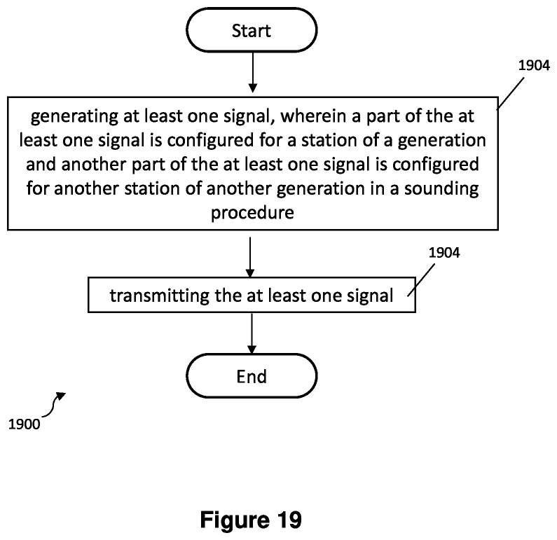

FIG. 19 shows a flow diagram 1900 illustrating a communication method implemented by an AP according to various embodiments of the present disclosure. In step 1902, a step of generating at least one signal is carried out, wherein a part of the at least one signal is configured for a first STA of a first generation and another part of the at least one signal is configured for a second STA of a second generation in a sounding procedure. In step 1904, a step of transmitting the at least one signal is carried out. In one embodiment, at least a part of the at least one signal generated by the AP in step 1902 includes information for the second STA and the first STA does not recognize the information. In another embodiment, the step of generating the at least one signal comprises successively generating three different signals which are a NDPA frame indicating a sounding sequence of the sounding procedure, a Sounding NDP carrying a field for channel estimation and a Trigger frame carrying information to solicit a response signal from the first STA and the second STA.

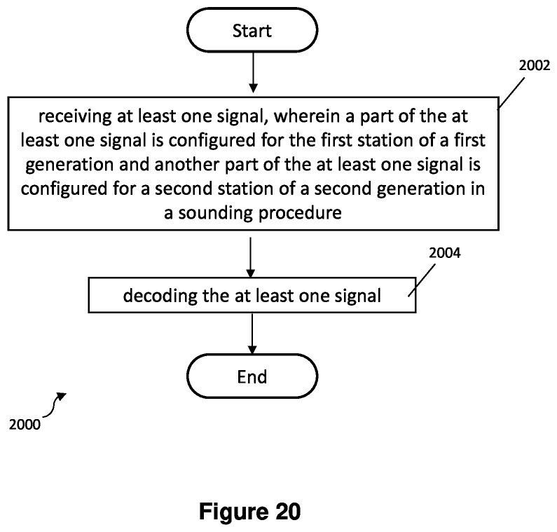

FIG. 20 shows a flow diagram 2000 illustrating a communication method implemented by a STA of a generation according to various embodiments of the present disclosure. In step 2002, a step of receiving at least one signal is carried out, wherein a part of the at least one signal is configured for the STA and another part of the at least one signal is configured for another STA of another generation in a sounding procedure. In step 2004, a step of decoding the at least one signal is carried out. In one embodiment, at least a part of the at least one signal received by the STA in step 2002 includes information for the other station and the STA does not recognize the information. In another embodiment, the step of receiving the at least one signal comprises successively receiving three different signals which are a NDPA frame indicating a sounding sequence of the sounding procedure, a Sounding NDP carrying a field for channel estimation and a Trigger frame carrying information to solicit a response signal from the STA.

In the following paragraphs, a first embodiment of the present disclosure where two or more separate HE sounding sequence is simultaneously carried out on different frequency segments to initiate an aggregated TB sounding procedure is described.

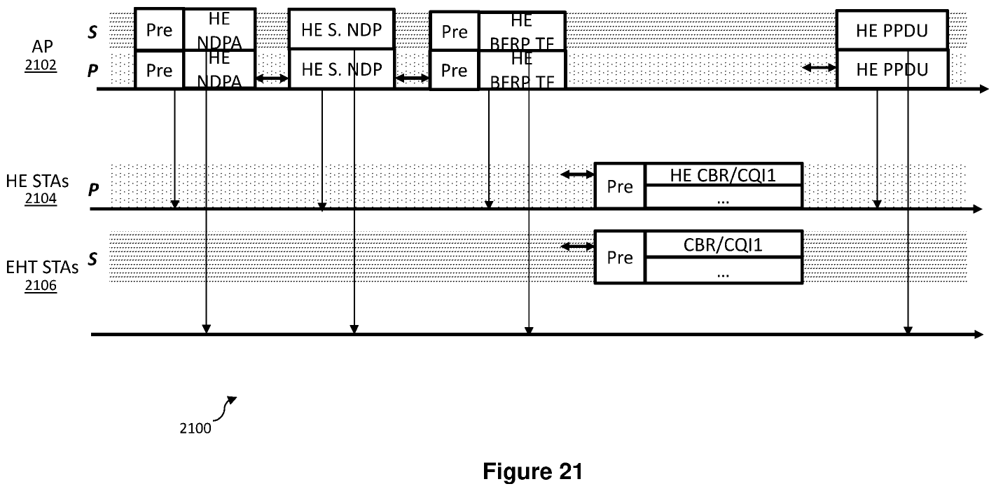

FIG. 21 depicts a flow diagram 2100 illustrating an example A-PPDU sounding procedure according to the first embodiment of the present disclosure. According to this embodiment, HE sounding sequence is reused in the aggregated TB sounding procedure where an AP 2102 carries more than one HE sounding sequence separately but simultaneously on different frequency segments (e.g., primary channel (P) and secondary channel(S)), where different non-AP STAs (HE STAs 2104, EHT STAs 2106) being located respectively.

More specifically, the AP 2102 simultaneously transmits a first DL PPDU that carries two separate HE NDPA frames on the primary channel and on the secondary channel to initiate aggregated TB sounding procedures for HE STAs 2104 parking on the primary channel (P) and EHT STAs 2106 parking on the secondary channel(S), respectively. After a SIFS, the AP 2102 simultaneously transmits a second aggregated signal comprising two separate HE Sounding NDPs (HE S. NDP) to the HE STAs 2104 and the EHT STAs 2106 respectively. After a SIFS, the AP 2102 transmits a third signal comprising two separate HE BFRP Trigger frame to the HE STAs 2104 and the EHT STAs 2106 to solicit Beamforming Report feedback from them respectively. After a SIFS, the solicited HE STAs 2104 and the EHT STAs 2106 in response transmit TB PPDUs containing HE Beamforming Report feedbacks to the AP 2102. Subsequently, the AP 2102/the non-AP STAs 2104, 2106 may transmit DL/UL A-PPDU containing multiple HE PPDUs, in this case, after a SIFS, the AP 2102 transmits two separate HE PPDUs simultaneously to the HE STAs 2104 and EHT STAs 2106.

In this embodiment, the participating STAs which are located in non-primary frequency segment (e.g., EHT STAs 2104) shall support transmission/reception of an HE PPDU not overlapping the primary channel. Advantageously, this is the simplest solution to the problem but the efficiency of transmission in secondary may be not as good as EHT PPDU with different modulation color scheme (MCS) and usage of multi-user resource units (MRU).

In the following paragraphs, a second embodiment of the present disclosure where multiple HE NDP Announcement frames and HE BFRP Trigger frames are used in an aggregated TB sounding procedure is described.

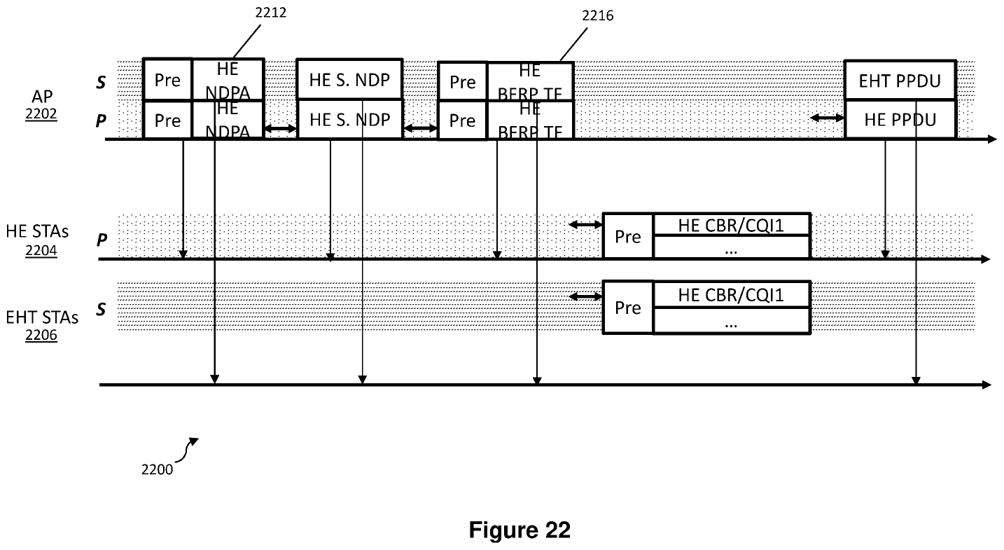

FIG. 22 depicts a flow diagram 2200 illustrating an example A-PPDU sounding procedure according to the second embodiment of the present disclosure. According to this embodiment, HE NDPA frame and HE Sounding NDP are reused in the aggregated TB sounding procedure.

More specifically, an AP 2202 transmits one or more DL PPDUs 2212 that carries multiple HE NDPA frames by OFDMA transmission to non-AP STAs to initiate an aggregated TB sounding procedure. After a SIFS, the AP 2202 simultaneously transmits multiple aligned HE Sounding NDPs to non-AP STAs of different generations, in this case the HE STAs 2204 parking on the primary channel (P) and the EHT STAs 2206 parking on the secondary channel(S) respectively. After a SIFS, the AP 2202 transmits one or more DL PPDUs 2216 that carries BFRP Trigger frames by OFDMA transmission to solicit Beamforming Report feedback from the STAs of different generation, i.e., HE STAs 2204 and EHT STAs 2206, simultaneously. After a SIFS, the solicited HE STAs 2204 and the EHT STAs 2206 in response transmit HE TB PPDUs containing HE Beamforming Report feedbacks simultaneously to the AP 2202. Subsequently, the AP 2202/the non-AP STAs 2204, 2206 may transmit DL/UL A-PPDU containing an EHT PPDU in the secondary channel.

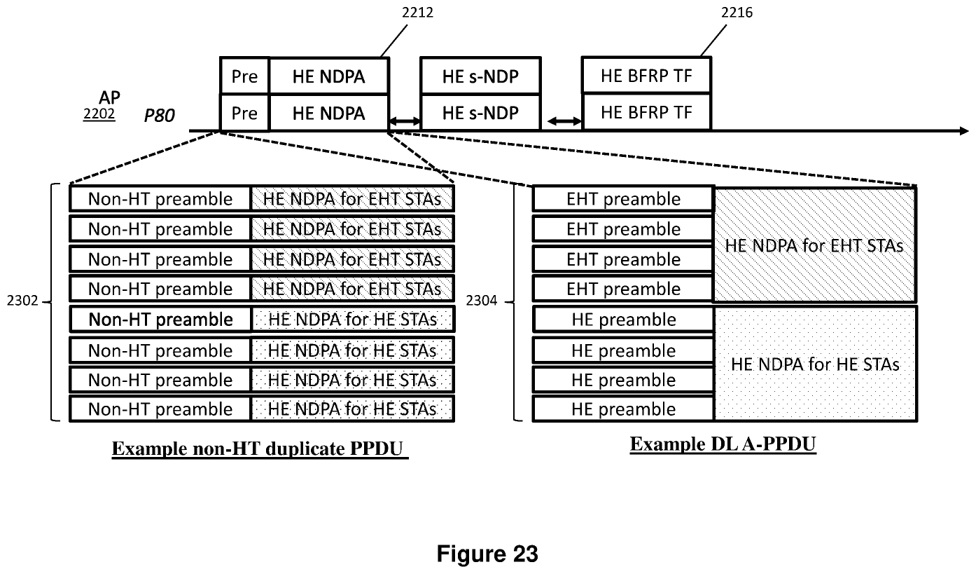

FIG. 23 depicts an example format of a DL PPDU 2212 carrying multiple HE NDP Announcement frames according to an embodiment of the present disclosure. The multiple HE NDP Announcement frames are carried either in a non-HT duplicate PPDU 2302 or a DL A-PPDU 2304. The non-HT duplicate PPDU 2302 includes or consists of a non-HT preamble and an HE NDPA frame. The HE NDPA frames for STAs of different generations are carried in the payload in different frequency segments in the non-HT duplicate PPDU 2302 and thus can also be regarded as multiple non-HT duplicate PPDUs. In this example, the non-HT duplicate PPDU 2302 carries HE NDPA frames for HE STAs 2204 in the primary 80 MHz channel and HE NDPA frames for EHT STAs 2206 in the secondary channel. Where the NDPA frames are carried in a DL A-PPDU 2304, such DL A-PPDU 2304 may include or consists of a preamble and an HE NDPA frame, the HE NDPA frames for STAs of different generations are carried in PPDUs of corresponding format. In this example, the DL A-PPDU 2304 carries a preamble in an HE format and an HE NDPA frame for HE STAs 2204 in the primary 80 MHz channel and a preamble in an EHT format and an HE NDPA frame for EHT STAs 2206 in the secondary channel.

Upon receipt of the NDPA frames 2212 targeted for 80/160 MHz sounding, the subcarrier indices for which a beamforming feedback is sent back by the beamformee follow the HE beamforming rules, that is, the feedback subcarriers indices are indicated by the first and last 26-tone RU index indicated in HE NDPA frames 2212.

Table 2 illustrates subcarrier indices of an HE/EHT 80/160 MHz beamforming feedback, where Ng is number of grouping.

TABLE 2

| | | Partial | |
|---|---|---|---|
| Bandwidth | Type | BW size | Superset of subcarrier indices |
| 80 MHz | HE | 242, 484, | StartIndice_{StartRU}:Ng:EndIndice_{EndRU} |
| | | 996 | |
| | EHT | 242 | [−500:Ng:−260], [−252:Ng:−12], [12:Ng:252], |
| | | | [260:Ng:500] |
| | | 484 | [−500:Ng:−260, −252:Ng:−12], [12:Ng:252, |
| | | | 260:Ng:500] |
| | | 996 | [−500:Ng:−260, −252:Ng:−12, 12:Ng:252, |
| | | | 260:Ng:500] |
| 160 MHz | HE | 242, 484, | StartIndice_{StartRU}:Ng:EndIndice_{EndRU} |
| | | 996, | |
| | | 2 × 996 | |
| | EHT | 242 | [−1012:Ng:−772], [−764:Ng:−524], [−500:Ng:−260], |
| | | | [−252:Ng:−12], [12:Ng:252], [260:Ng:500], |
| | | | [524:Ng:764], [772:Ng:1012] |
| | | 484 | [−1012:Ng:−772, −764:Ng:−524], |
| | | | [−500:Ng:−260, −252:Ng:−12], |
| | | | [12:Ng:252, 260:Ng:500], [524:Ng:764, 772:Ng:1012] |
| | | 996 | [−1012:Ng:−772, −764:Ng:−524, −500:Ng:−260, −252:Ng:−12], |
| | | | [12:Ng:252, 260:Ng:500, 524:Ng:764, 772:Ng:1012] |
| | | 2 × 996 | [−1012:Ng:−772, −764:Ng:−524, −500:Ng:−260, −252:Ng:−12, |
| | | | 12:Ng:252, 260:Ng:500, 524:Ng:764, 772:Ng:1012] |

Detailed starting and ending subcarrier indices for 26-tone RU are illustrated in Tables 4-7.

When number of grouping (Ng) is 4, the feedback subcarrier indices for EHT are covered and the performances is same as EHT sounding; whereas when Ng is 16, the feedback subcarriers indices are different from EHT and the results of estimation for part of subcarriers between each feedback subcarrier may not be as accurate as EHT sounding.

For example, when 80 MHz sounding is carried and Ng is 16, the non-AP STA feedback beamforming information follows HE results with subcarrier indices of [−500:16:−4, 4:16:500] as shown in Table 3; whereas on AP side, the result for subcarriers [−260:252], [252:260] is estimated from feedback subcarriers [−260,−244], [244, 260] respectively, which may be not as accurate as in EHT sounding. The AP may either ignore the inaccuracy or select a proper interpolation scheme to eliminate the impact. Nonetheless, the AP shall select RU index indicated in HE NDPA frame carefully to cover the range of subcarriers indices needed for EHT transmissions.

Table 3 shows subcarrier indices of an HE/EHT 80 MHz beamforming feedback when the number of grouping Ng is 16.

TABLE 3

| Bandwidth | Type | Superset of subcarrier indices |
|---|---|---|
| 80 MHz | HE | [−500:16:−4], [4:16:500] |
| | EHT | [−500:16:−260, −252:16:−12], |
| | | [12:16:252, 260:16:500] |

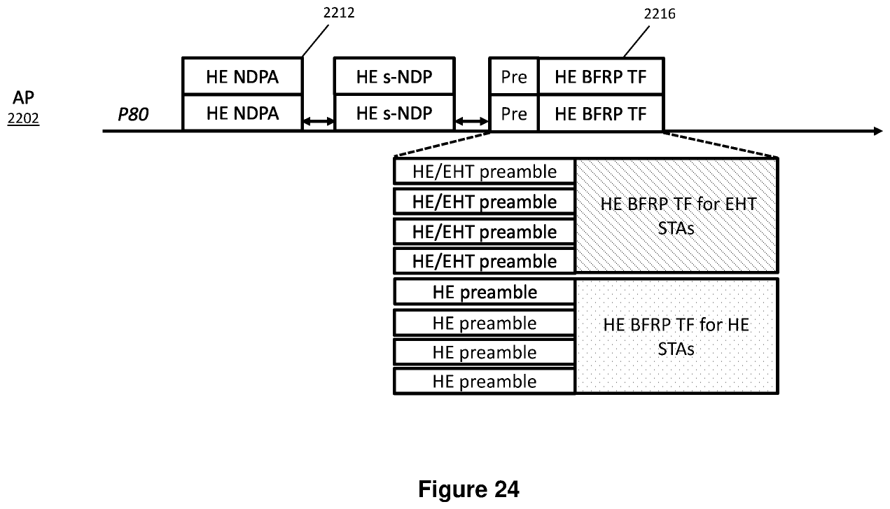

FIG. 24 depicts an example format of a DL PPDU 2216 carrying multiple BFRP Trigger frames according to an embodiment of the present disclosure. The BFRP Trigger frames can be carried by an HE PPDU when the bandwidth is equal to 160 MHz or an A-PPDU. In this example, the DL PPDU 2216 is an HE PPDU, the HE PPDU having a preamble in an HE format carrying HE BFRP TF for HE STAs 2204 in the primary 80 MHz channel and HE BFRP TF for EHT STAs 2206 for EHT STAs in the secondary channel; whereas the DL PPDU 2216 is an A-PPDU consisting of an HE PPDU and an EHT PPDU, the HE PPDU carrying a preamble in an HE format and HE BFRP TF for HE STAs 2204 in the primary 80 MHz channel and the EHT PPDU carrying a preamble in an EHT format and HE BFRP TF for EHT STAs 2206 in the secondary channel. Advantageously, the disclosure according to the second embodiment causes minimal change for AP and STA devices. The only change required is to enable the STAs to transmit/receive an HE PPDU not covering the primary channel and the adjustment on receiver side of the beamforming feedback. STAs parking on the secondary channel can participate in sounding procedure without reception on full bandwidth PPDU.

In the following paragraphs, a third embodiment of the present disclosure where multiple HE NDP Announcement frames and EHT BFRP Trigger frames are used in an aggregated TB sounding procedure is described.

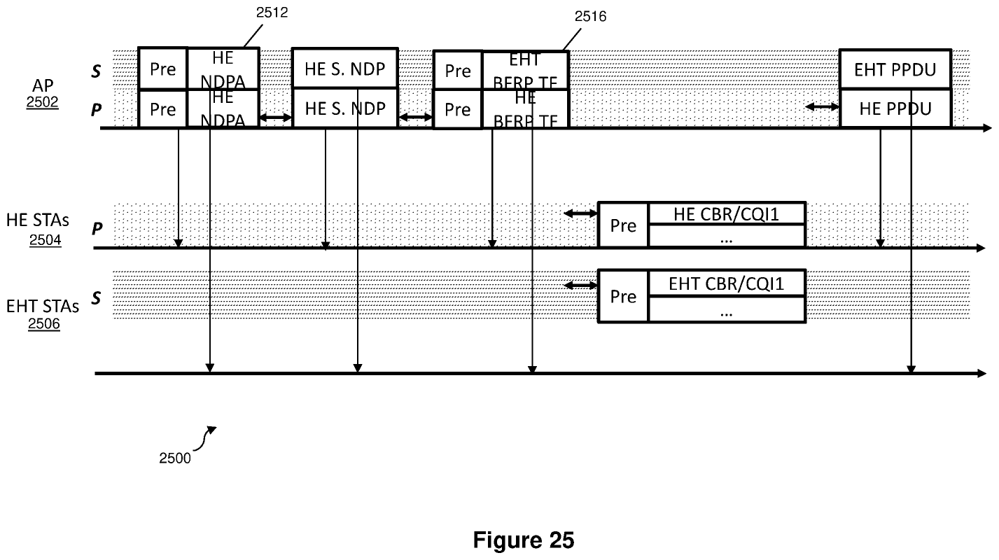

FIG. 25 depicts a flow diagram 2500 illustrating an example A-PPDU sounding procedure according to the third embodiment of the present disclosure. According to this embodiment, HE NDPA frame and HE Sounding NDP are reused in the aggregated TB sounding procedure.

More specifically, an AP 2502 transmits one or more DL PPDUs 2512 that carries multiple HE NDPA frames by OFDMA transmission to non-AP STAs to initiate an aggregated TB sounding procedure. After a SIFS, the AP 2502 simultaneously transmits multiple aligned HE Sounding NDPs to non-AP STAs of different generations, in this case the HE STAs 2504 parking on the primary channel (P) and the EHT STAs 2506 parking on the secondary channel(S) respectively. After a SIFS, the AP 2502 transmits one or more DL PPDUs 2516 that carries different BFRP Trigger frames to STAs of different generation, i.e., HE BFRP TF to HE STAs 2504 and EHT BFRP TF to EHT STAs 2506, simultaneously to solicit Beamforming Report feedback from the STAs. After a SIFS, the solicited HE STAs 2504 and the EHT STAs 2506 in response transmit TB PPDUs containing corresponding Beamforming Report feedback, i.e., HE CBR/CQI frame and EHT CBR/CQI frame, simultaneously to the AP 2502. Subsequently, the AP 2502/the non-AP STAs 2504, 2506 may transmit DL/UL A-PPDU containing an HE PPDU in the primary channel and an EHT PPDU in the secondary channel, respectively.

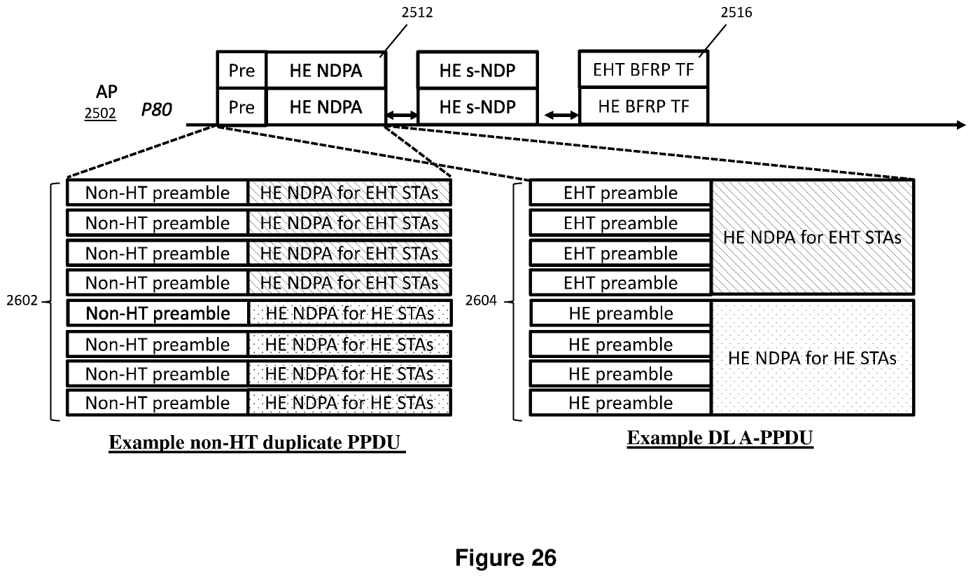

FIG. 26 depicts an example format of a DL PPDU 2512 carrying multiple HE NDP Announcement frames according to an embodiment of the present disclosure. The multiple HE NDP Announcement frames are carried either in a non-HT duplicate PPDU 2602 or a DL A-PPDU 2604. The non-HT duplicate PPDU 2602 includes or consists of a non-HT preamble and an HE NDPA frame. The HE NDPA frames for STAs of different generations are carried in the payload in different frequency segments in the non-HT duplicate PPDU 2602 and thus can also be regarded as multiple non-HT duplicate PPDUs. In this example, the non-HT duplicate PPDU 2602 carries HE NDPA frames for HE STAs 2504 in the primary 80 MHz channel and HE NDPA frames for EHT STAs 2506 in the secondary channel. Where the NDPA frames are carried in a DL A-PPDU 2604, such DL A-PPDU 2604 may include or consists of a preamble and an HE NDPA frame, the HE NDPA frames for STAs of different generations are carried in PPDUs of corresponding format. In this example, the DL A-PPDU 2604 carries a preamble in an HE format and an HE NDPA frame for HE STAs 2504 in the primary 80 MHz channel and a preamble in an EHT format and an HE NDPA frame for EHT STAs 2506 in the secondary channel.

In the third embodiment of the present disclosure, the AP can implicitly indicate (Option 1) or explicit indicate (Option 2) an aggregated TB Sounding procedure to post-HE STAs such as EHT STAs. In particular, under Option 1, the AP transmits a DL PPDU carrying the NDPA frame not overlapping the primary channel. This can serve as an implicit indication of an aggregated TB sounding procedure. A STA parking on a secondary channel will be aware of the initiation of an aggregated TB sounding procedure when receives an HE NDPA frame carried by a PPDU not overlapping the primary channel. Alternatively, under Option 2, the AP transmits an HE NDPA frame carrying an explicit indication of an aggregated TB sounding procedure. For example, the reserved values in a Partial BW Info subfield of the HE NDPA frame can be used to indicate the first and last RU, which in turn, indicate an aggregated TB sounding procedure. It is noted that in this case the default resolution for RU indicated the Partial BW Info subfield should be larger than 26-tone, e.g., 242-tone or 484-tone. A STA will be aware of the initiation of an aggregated TB sounding procedure when it receives an HE NDPA frame using reserved values in the Partial BW Info subfield.

Upon receipt of the HE NDPA frames 2512 initiating aggregated sounding for non-primary 80/160 MHz, the subcarrier indices for which a beamforming feedback is sent back by the beamformee follow the HE beamforming rules. If the partial feedback is indicated by 26-tone RU index in the HE NDPA frames 2512, the receiver STA may refer to the corresponding 242/484/996/2×996-tone RU covered by the range.

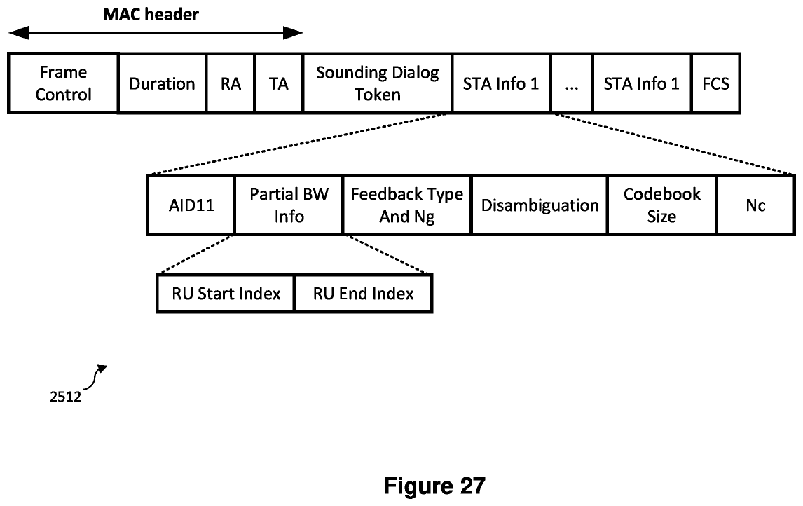

FIG. 27 depicts an example format of an HE NDP Announcement frame 2512 according to an embodiment of the present disclosure. The HE NDPA frame 2512 may include (or consist of) a Frame Control field, a Duration field, a RA field, a TA field, a Sounding Dialog Token field, one or more STA Info fields and a FCS (frame check sequence) field. The Frame Control field, the Duration field, the RA field and the TA field may be grouped as MAC header. Each STA Info field may include (or consist of) an AID11 field, a Partial BW Info field, a Feedback Type And Ng field, a Disambiguation field, a Codebook Size field and a Nc field. The Partial BW Info field may include (or consist of) a RU Start Index field and a RU End Index field which indicate the first and last RU between which the beamformer is requesting feedback. An explicit indication of an aggregated TB sounding procedure can be included in the RU Start Index field of the NDPA frame 2512 using 74-127 (which is reserved in 802.11ax) to indicate RU index.

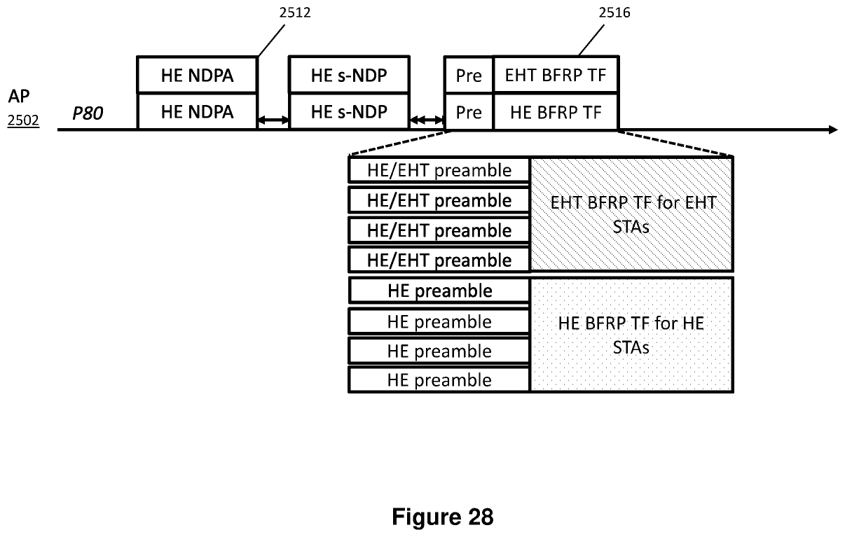

FIG. 28 depicts an example format of a DL PPDU 2516 carrying an EHT BFRP TF and an HE BFRP TF according to an embodiment of the present disclosure. The BFRP Trigger frames can be carried by an HE PPDU when the bandwidth is equal to 160 MHz or an A-PPDU. In this example, the DL PPDU 2516 may be an HE PPDU, the HE PPDU having a preamble in an HE format carrying HE BFRP TF for HE STAs 2504 in the primary 80 MHz channel and EHT BFRP TF for EHT STAs 2506 for EHT STAs in the secondary channel; whereas the DL PPDU 2516 may be an A-PPDU consisting of an HE PPDU and an EHT PPDU, the HE PPDU carrying a preamble in an HE format and HE BFRP TF for HE STAs 2504 in the primary 80 MHz channel and the EHT PPDU carrying a preamble in an EHT format and EHT BFRP TF for EHT STAs 2506 in the secondary channel. Advantageously, although more change is required for AP and STA devices as compared to that of the second embodiment, a sounding performance same as EHT sounding sequence may be achieved. There is no new format of PPDU is required for the sounding sequence.

In the following paragraphs, a fourth embodiment of the present disclosure where an EHT Announcement frame and an EHT BFRP Trigger frame are used in an aggregated TB sounding procedure is described.

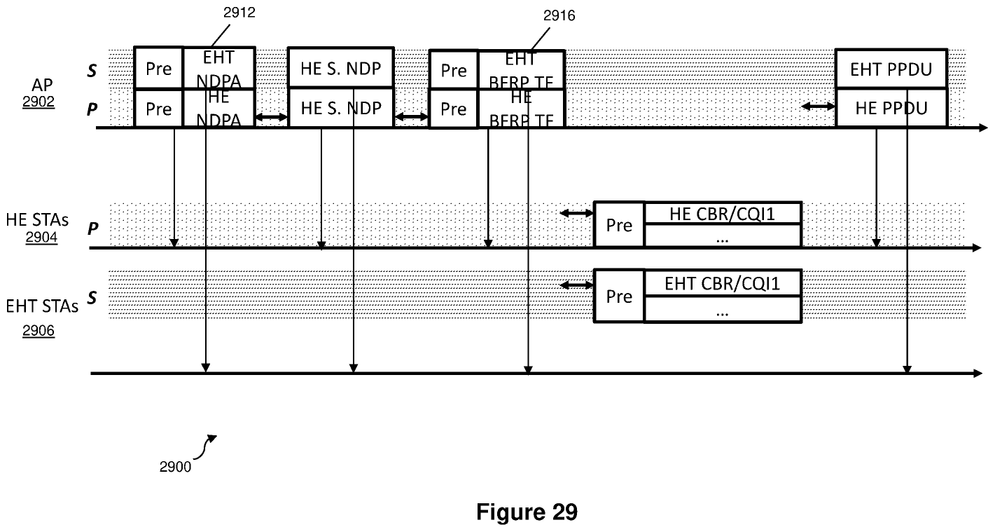

FIG. 29 depicts a flow diagram 2900 illustrating an example A-PPDU sounding procedure according to the fourth embodiment of the present disclosure. According to this embodiment, HE NDPA frame, EHT NDPA frame and HE Sounding NDP are reused in the aggregated TB sounding procedure.

More specifically, an AP 2902 transmits a DL PPDU 2912 that carries HE NDP Announcement and EHT NDP Announcement frames to initiate an aggregated TB sounding procedure. The HE NDP Announcement frame is targeted at HE STAs and EHT STAs that are expected to transmit/receive an HE PPDU after the sounding procedure, whereas the EHT NDP Announcement frame is targeted at EHT STAs. After a SIFS, the AP 2902 simultaneously transmits multiple aligned HE Sounding NDPs to non-AP STAs of different generations, in this case the HE STAs 2904 parking on the primary channel (P) and the EHT STAs 2906 parking on the secondary channel(S) respectively. After a SIFS, the AP 2902 transmits one or more DL PPDUs 2916 that carries different BFRP Trigger frames to STAs of different generation, i.e., HE BFRP TF to HE STAs 2904 and EHT BFRP TF to EHT STAs 2906, simultaneously to solicit Beamforming Report feedback from the STAs. After a SIFS, the solicited HE STAs 2904 and the EHT STAs 2906 in response transmit TB PPDUs containing corresponding Beamforming Report feedback, i.e., HE CBR/CQI frame and EHT CBR/CQI frame, simultaneously to the AP 2902. Subsequently, the AP 2902/the non-AP STAs 2904, 2906 may transmit DL/UL A-PPDU containing an HE PPDU in the primary channel and an EHT PPDU in the secondary channel, respectively.

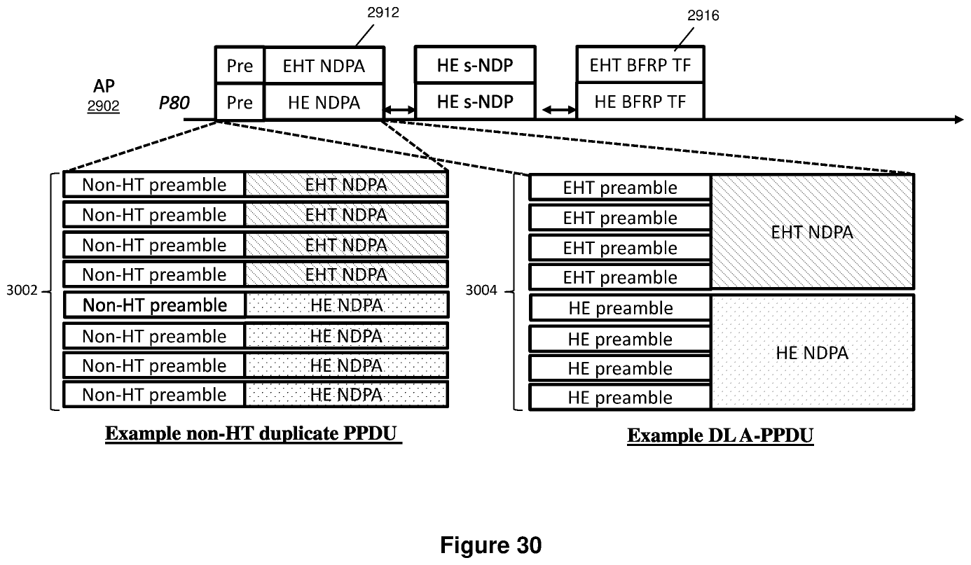

FIG. 30 depicts an example format of a DL PPDU 2912 carrying the HE and EHT NDP Announcement frames according to an embodiment of the present disclosure. The HE and EHT NDP Announcement frames are carried either in a non-HT duplicate PPDU 3002 or a DL A-PPDU 3004. Such non-HT duplicate PPDU 3002 includes or consists of a non-HT preamble, an HE NDPA frame and an EHT NDPA frame. The HE and EHT NDPA frames for STAs of different generations are carried in the payload in different frequency segments in the non-HT duplicate PPDU 3002 and thus can also be regarded as multiple non-HT duplicate PPDUs. In this example, the non-HT duplicate PPDU 3002 carries an HE NDPA frame for HE STAs 2904 (and EHT STAs 2906 that are expected to transmit/receive an HE PPDU after the sounding procedure) in the primary 80 MHz channel and an EHT NDPA frame for EHT STAs 2906 in the secondary channel. Where the NDPA frames are carried in a DL A-PPDU 3004, such DL A-PPDU 3004 may include or consists of a preamble and an HE NDPA frame, the HE NDPA frames for STAs of different generations are carried in PPDUs of corresponding format. In this example, the DL A-PPDU 3004 carries a preamble in an HE format and an HE NDPA frame for HE STAs 2904 in the primary 80 MHz channel and a preamble in an EHT format and an EHT NDPA frame for EHT STAs 2906 in the secondary channel.

In the fourth embodiment of the present disclosure, the AP can implicitly indicate (Option 1) or explicit indicate (Option 2) an aggregated TB Sounding procedure to post-HE STAs such as EHT STAs. In particular, under Option 1, the AP transmits a DL PPDU carrying the EHT NDPA frame not overlapping the primary channel. This can serve as an implicit indication of an aggregated TB sounding procedure according to this embodiment. A STA parking on a secondary channel will be aware of the initiation of an aggregated TB sounding procedure when receives an EHT NDPA frame carried by a PPDU not overlapping the primary channel. Alternatively, under Option 2, the AP transmits an EHT NDPA frame carrying an explicit indication of an aggregated TB sounding procedure. For example, one bit in reserved subfields in STA Info field of the EHT NDPA frame can be used as an explicit indication to indicate an aggregated TB sounding procedure. A STA will be aware of the initiation of an aggregated TB sounding procedure when it receives an EHT NDPA frame indicating using the one bit in the reserve subfields in the STA Info field.

Upon receipt of the EHT NDPA frames 2912 triggering aggregated sounding for non-primary 80/160 MHZ, the subcarrier indices for which a beamforming feedback is sent back by the beamformee follow the EHT beamforming rules. The receiver STA may then expect reception of a subsequent HE sounding NDP.

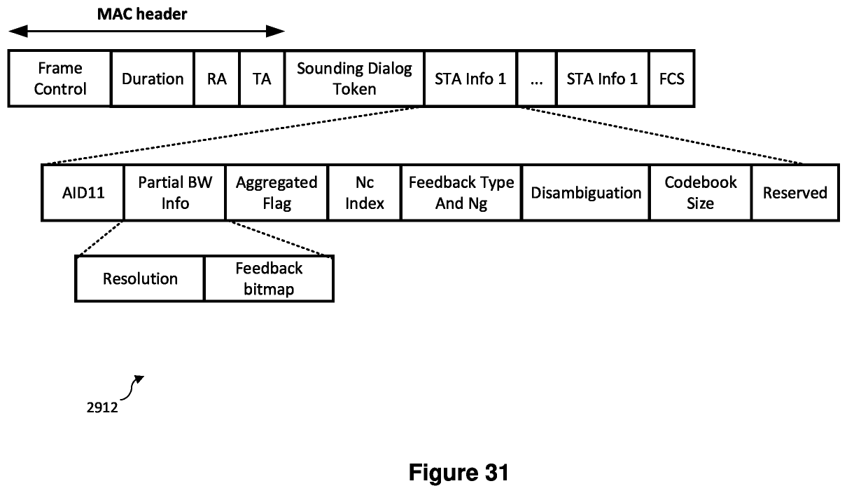

FIG. 31 depicts an example format of an EHT NDP Announcement frame 2912 according to an embodiment of the present disclosure. The EHT NDPA frame 2912 may include (or consist of) a Frame Control field, a Duration field, a RA field, a TA field, a Sounding Dialog Token field, one or more STA Info fields and a FCS field. The Frame Control field, the Duration field, the RA field and the TA field may be grouped as MAC header. Each STA Info field may include (or consist of) an AID11 field, a Partial BW Info field, an Aggregated Flag field, a NC Index field, a Feedback Type And Ng field, a Disambiguation field, a Codebook Size field and a Reserved field. The Partial BW Info field may include (or consist of) a Resolution field and a Feedback Bitmap field which respectively indicate the resolution bandwidth for each bit in the bitmap (20 MHz/40 MHZ) and the subchannel(s) for which the EHT beamformer is requesting feedback. An explicit indication of an aggregated TB sounding procedure can be included using the Aggregated Flag field. Alternatively or additionally, the Reserved field after the Codebook Size field can also be used to indicate the aggregated TB sounding procedure.

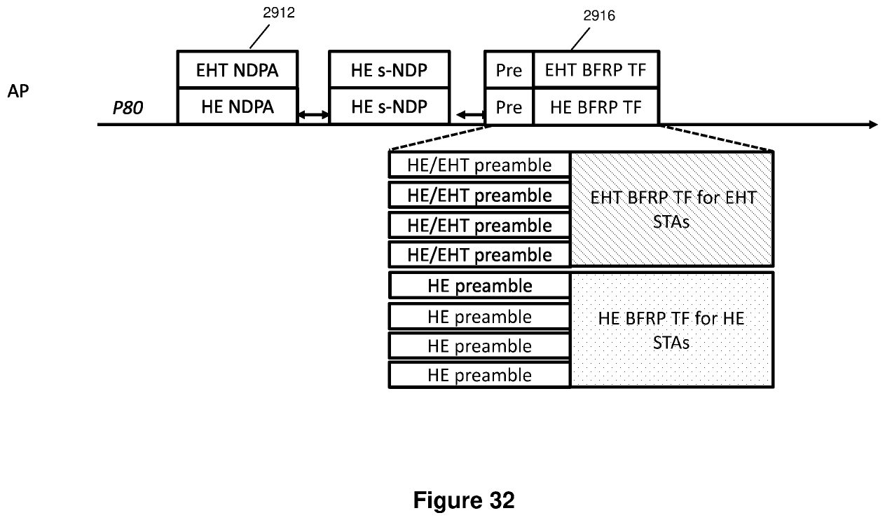

FIG. 32 depicts an example format of a DL PPDU 2916 carrying an EHT BFRP TF and an HE BFRP TF according to an embodiment of the present disclosure. The BFRP Trigger frames can be carried by an HE PPDU when the bandwidth is equal to 160 MHz or an A-PPDU. In this example, the DL PPDU 2916 may be an HE PPDU, the HE PPDU having a preamble in an HE format carrying HE BFRP TF for HE STAs 2904 in the primary 80 MHz channel and EHT BFRP TF for EHT STAs 2906 for EHT STAs in the secondary channel; whereas the DL PPDU 2916 may be an A-PPDU consisting of an HE PPDU and an EHT PPDU, the HE PPDU carrying a preamble in an HE format and HE BFRP TF for HE STAs 2904 in the primary 80 MHz channel and the EHT PPDU carrying a preamble in an EHT format and EHT BFRP TF for EHT STAs 2906 in the secondary channel. Advantageously, although new sounding sequence needs to be defined as compared to those of the second and third embodiments, a sounding performance same as EHT sounding sequence may be achieved and STAs only need to understand the new sounding sequence, no new format of PPDU is required.

In the following paragraphs, a fifth embodiment of the present disclosure where an EHT Announcement frame, a special EHT sounding NDP and an EHT BFRP Trigger frame are used in an aggregated TB sounding procedure is described.

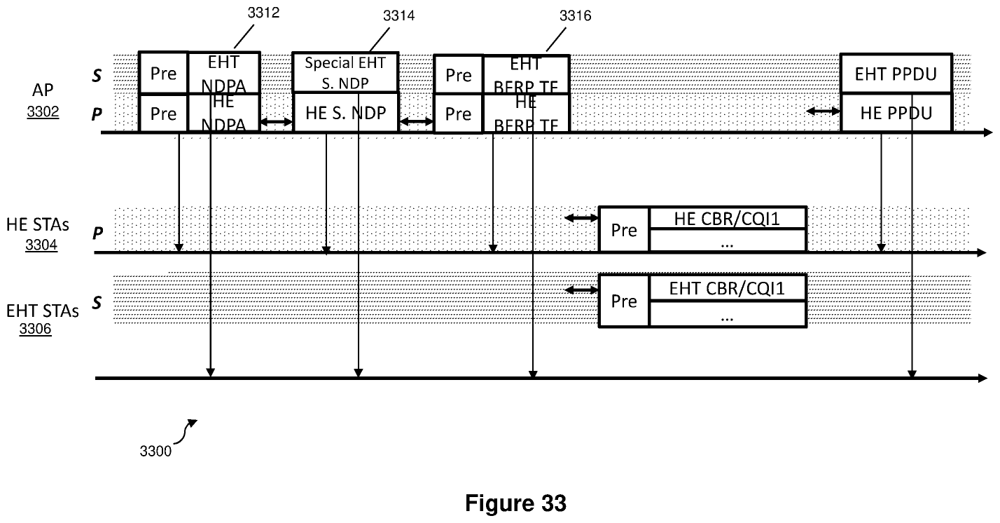

FIG. 33 depicts a flow diagram 3300 illustrating an example A-PPDU sounding procedure according to the fifth embodiment of the present disclosure. According to this embodiment, HE NDPA frame, EHT NDPA frame, HE Sounding NDP and EHT Sounding NDP are reused in the aggregated TB sounding procedure.

More specifically, an AP 3302 transmits a DL PPDU 3312 that carries HE NDP Announcement and EHT NDP Announcement frames to initiate an aggregated TB sounding procedure. The HE NDP Announcement frame is targeted at HE STAs and EHT STAs that are expected to transmit/receive an HE PPDU after the sounding procedure, whereas the EHT NDP Announcement frame is targeted at EHT STAs. After a SIFS, the AP 3302 simultaneously transmits an HE Sounding NDP and a special EHT Sounding NDP 3314 that are aligned with each other to non-AP STAs of different generations, in this case the HE STAs 3304 parking on the primary channel (P) and the EHT STAs 3306 parking on the secondary channel(S) respectively. After a SIFS, the AP 3302 transmits one or more DL PPDUs 3316 that carries different BFRP Trigger frames to STAs of different generation, i.e., HE BFRP TF to HE STAs 3304 and EHT BFRP TF to EHT STAs 3306, simultaneously to solicit Beamforming Report feedback from the STAs. After a SIFS, the solicited HE STAs 3304 and the EHT STAs 3306 in response transmit TB PPDUs containing corresponding Beamforming Report feedback, i.e., HE CBR/CQI frame and EHT CBR/CQI frame, simultaneously to the AP 3302. Subsequently, the AP 3302/the non-AP STAs 3304, 3306 may transmit DL/UL A-PPDU containing an HE PPDU in the primary channel and an EHT PPDU in the secondary channel, respectively.

The HE and EHT NDP Announcement frames are carried either in a non-HT duplicate PPDU or a DL A-PPDU. Such non-HT duplicate PPDU includes or consists of a non-HT preamble, an HE NDPA frame and an EHT NDPA frame. The HE and EHT NDPA frames for STAs of different generations are carried in the payload in different frequency segments in the non-HT duplicate PPDU and thus can also be regarded as multiple non-HT duplicate PPDUs. In this example, the non-HT duplicate PPDU carries an HE NDPA frame for HE STAs 3304 (and EHT STAs 3306 that are expected to transmit/receive an HE PPDU after the sounding procedure) in the primary 80 MHz channel and an EHT NDPA frame for EHT STAs 3306 in the secondary channel. Where the NDPA frames are carried in a DL A-PPDU, such DL A-PPDU may include or consists of a preamble and an HE NDPA frame, the HE NDPA frames for STAs of different generations are carried in PPDUs of corresponding format. In this example, the DL A-PPDU carries a preamble in an HE format and an HE NDPA frame for HE STAs 3304 in the primary 80 MHz channel and a preamble in an EHT format and an EHT NDPA frame for EHT STAs 3306 in the secondary channel.

The AP can implicitly indicate (Option 1) or explicit indicate (Option 2) an aggregated TB Sounding procedure to post-HE STAs such as EHT STAs. In particular, under Option 1, the AP transmits a DL PPDU carrying the EHT NDPA frame not overlapping the primary channel. This can serve as an implicit indication of an aggregated TB sounding procedure according to this embodiment. A STA parking on a secondary channel will be aware of the initiation of an aggregated TB sounding procedure when receives an EHT NDPA carried by a PPDU not overlapping the primary channel. Alternatively, under Option 2, the AP transmits an EHT NDPA frame carrying an explicit indication of an aggregated TB sounding procedure. For example, one bit in reserved subfields in STA Info field of the EHT NDPA frame can be used as an explicit indication to indicate an aggregated TB sounding procedure. A STA will be aware of the initiation of an aggregated TB sounding procedure when it receives an EHT NDPA frame indicating using the one bit in the reserve subfields in the STA Info field.

Upon receipt of the EHT NDPA frames 2912 triggering aggregated sounding for non-primary 80/160 MHZ, the subcarrier indices for which a beamforming feedback is sent back by the beamformee follow the EHT beamforming rules. The receiver STA may then expect reception of a subsequent HE sounding NDP.

In this embodiment, the special EHT Sounding NDP in aggregated TB sounding procedure shall be aligned with HE Sounding NDP. In this case, the Special EHT Sounding NDP shall not include an EHT-SIG field. This special EHT Sounding NDP is a special case of an EHT Sounding NDP. Such special EHT Sounding NDP can be indicated by implicitly indicated (Option 1) or explicitly indicated (Option 2).

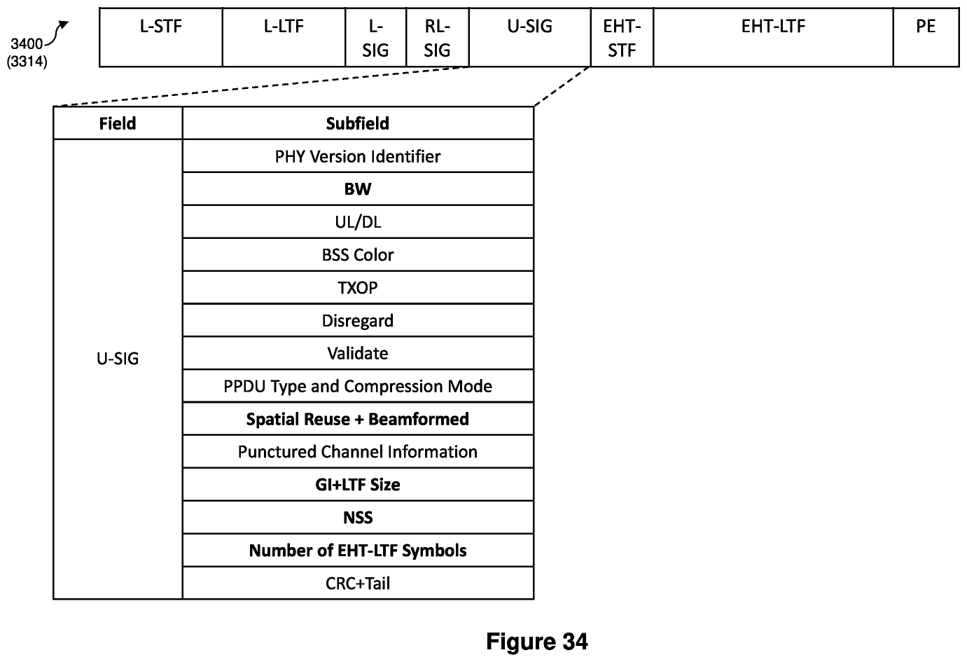

FIG. 34 depicts a first example format of a special EHT Sounding NDP 3400 according to an embodiment of the present disclosure. The special EHT Sounding NDP 3400 contains information which can be used as an implicit indication of an aggregated TB sounding procedure. The special EHT Sounding NDP 3400 comprises a L-STF, a L-LTF, a L-SIG field, a RL-SIG field, a U-SIG field, an EHT-STF, an EHT-LTF and a PE field. The U-SIG field further includes or consists of a PHY Version Identifier subfield, a BW subfield, a UL/DL subfield, a BSS Color subfield, a TXOP subfield, a Disregard subfield, a Validate subfield, a PPDU Type and Compression Mode subfield, a Spatial Reuse+Beamformed subfield, a Punctured Channel Information subfield, a GI+LTF Size subfield, a Number of Spatial Stream (NSS) subfield, a Number of EHT-LTF Symbols subfield and a Cyclic Redundancy Check (CRC)+Tail subfield. The BW subfield contains information BW and position from which the receiver STA will can verify if it is for an aggregated sounding and thus it will determine the PPDU format early. The GI+LTF Size subfield also contains information relating to an integration of the EHT-SIG field into U-SIG field.

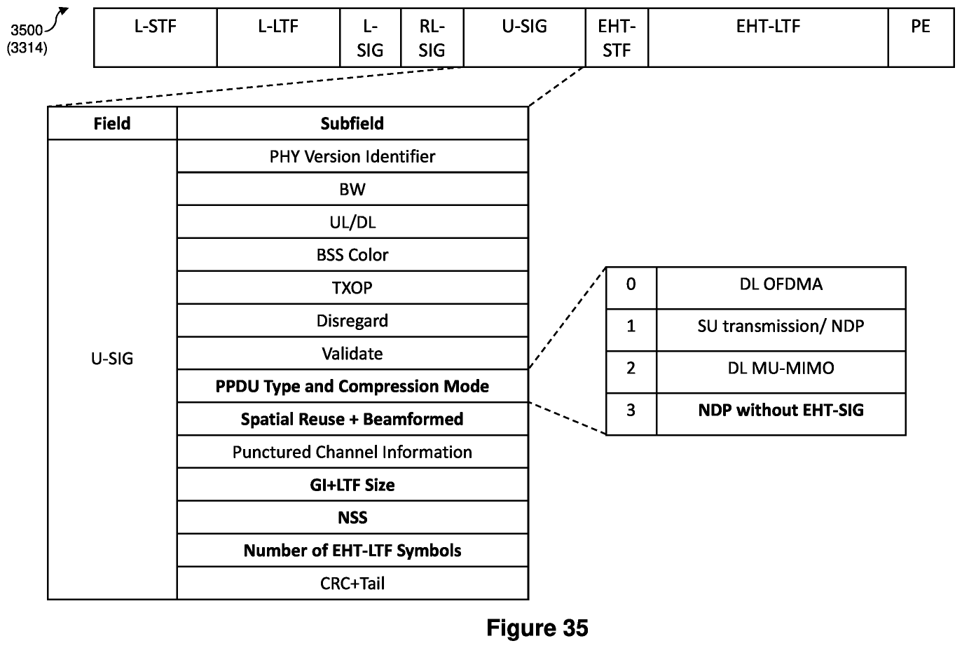

FIG. 35 depicts a second example format of a special EHT Sounding NDP 3500 according to an embodiment of the present disclosure. The special EHT Sounding NDP 3500 contains explicit indication of an aggregated TB sounding procedure. The special EHT Sounding NDP 3500 comprises a L-STF, a L-LTF, a L-SIG field, a RL-SIG field, a U-SIG field, an EHT-STF, an EHT-LTF and a PE field. The U-SIG field further includes or consists of a PHY Version Identifier subfield, a BW subfield, a UL/DL subfield, a BSS Color subfield, a TXOP subfield, a Disregard subfield, a Validate subfield, a PPDU Type and Compression Mode subfield, a Spatial Reuse+Beamformed subfield, a Punctured Channel Information subfield, a GI+LTF Size subfield, a Number of Spatial Stream (NSS) subfield, a Number of EHT-LTF Symbols subfield and a Cyclic Redundancy Check (CRC)+Tail subfield. A value of 3 in the PPDU Type and Compression Mode subfield indicates a sounding NDP without EHT-SIG field. The GI+LTF Size subfield also contains information relating to an integration of the EHT-SIG field into U-SIG field.

In the following paragraphs, a sixth embodiment of the present disclosure where an EHT Announcement frame, an EHT sounding NDP and an EHT BFRP Trigger frame are used in an aggregated TB sounding procedure is described.

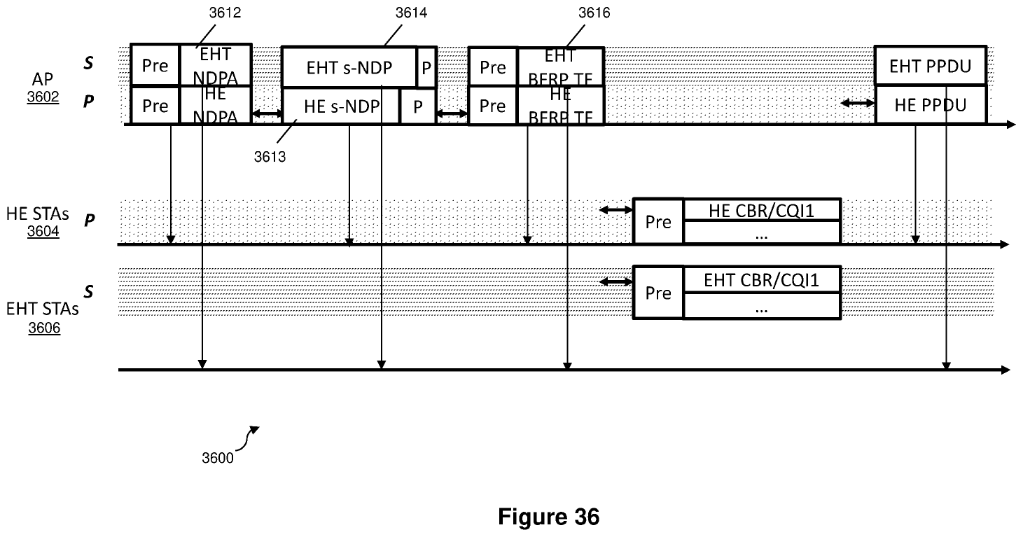

FIG. 36 depicts a flow diagram 3600 illustrating an example A-PPDU sounding procedure according to the sixth embodiment of the present disclosure. According to this embodiment, HE NDPA frame, EHT NDPA frame, HE Sounding NDP and EHT Sounding NDP are reused in the aggregated TB sounding procedure.

More specifically, an AP 3602 transmits a DL PPDU 3612 that carries HE and EHT NDP Announcement frames to initiate an aggregated TB sounding procedure. The HE NDP Announcement frame is targeted at HE STAs and EHT STAs that are expected to transmit/receive an HE PPDU after the sounding procedure, whereas the EHT NDP Announcement frame is targeted at EHT STAs. After a SIFS, the AP 3602 simultaneously transmits an HE Sounding NDP 3613 and an EHT Sounding NDP 3614 which are not orthogonally aligned with each other to non-AP STAs of different generations, in this case the HE STAs 3604 parking on the primary channel (P) and the EHT STAs 3606 parking on the secondary channel(S) respectively. After a SIFS, the AP 3602 transmits one or more DL PPDUs 3616 that carries different BFRP Trigger frames to STAs of different generation, i.e., HE BFRP TF to HE STAs 3604 and EHT BFRP TF to EHT STAs 3606, simultaneously to solicit Beamforming Report feedback from the STAs. After a SIFS, the solicited HE STAs 3604 and the EHT STAs 3606 in response transmit TB PPDUs containing corresponding Beamforming Report feedback, i.e., HE CBR/CQI frame and EHT CBR/CQI frame, simultaneously to the AP 3602. Subsequently, the AP 3602/the non-AP STAs 3604, 3606 may transmit DL/UL A-PPDU containing an HE PPDU in the primary channel and an EHT PPDU in the secondary channel, respectively. In this embodiment, the AP 3602 uses more than one Inverse Fast Fourier transform (IFFT) processor to generate multiple PPDUs in different basebands.

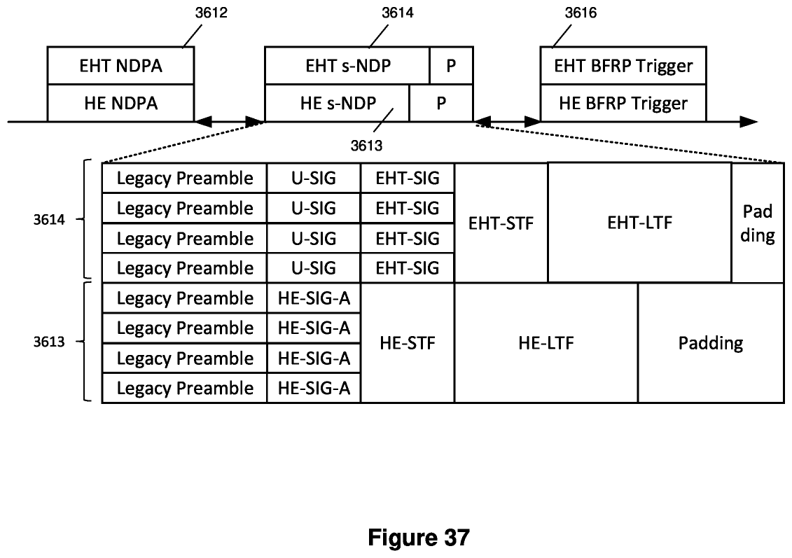

FIG. 37 depict an example HE Sounding NDP 3613 and an example EHT Sounding NDP 3614 which are not orthogonally aligned but are transmitted simultaneously in an aggregated trigger-based sounding procedure according to an embodiment of the present disclosure. The HE Sounding NDP 3613 comprises a legacy preamble and an HE-SIG-A field in each frequency segment of the primary 80 MHz frequency segment and an HE-STF and HE-LTF across full primary 80 MHz frequency segment; whereas the EHT Sounding NDP 3614 comprises a legacy preamble, a U-SIG field and an EHT-SIG field in each frequency segment of the secondary channel and an EHT-STF and an EHT-LTF across full secondary channel. According to this embodiment, Padding bits may be added at the end of the HE Sounding NDP and/or the EHT Sounding NDP to align the time domain of both NDPs.

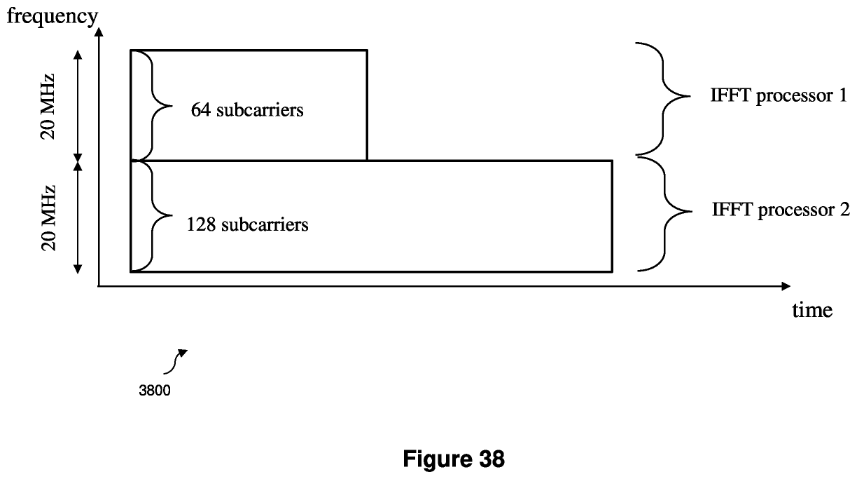

FIG. 38 depicts a block diagram 3800 illustrating an OFDMA transmission with multiple IFFT processors according to an embodiment of the present disclosure. In this embodiment, there are two IFFT processors (IFFT processor 1 and IFFT processor 2). The IFFT processor 1 is used by the AP to generate one or more symbols under 64 subcarriers while the IFFT processor 2 is used to generate one or more symbols under 128 subcarriers. With channel sounding such as SST, non-AP STAs are able to receive unaligned PPDUs. Non-AP STAs only receive the PPDU sent on the baseband they are allocated to.

In the following paragraphs, embodiments relating to two other variations in the Announcement frame, sounding NDP and BFRP Trigger frame used in an aggregated TB sounding procedure are described.

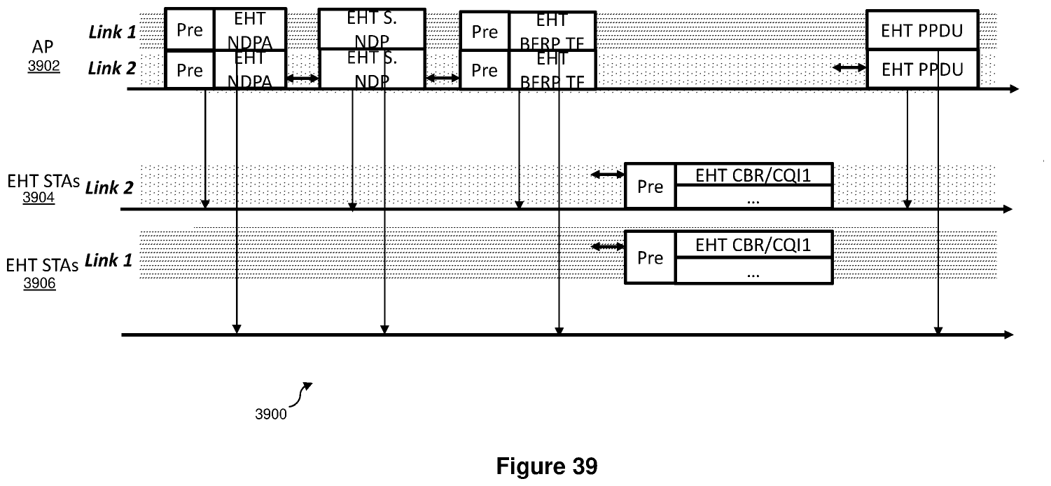

In one embodiment, an aggregated TB sounding sequence may be used in an A-PPDU and other type of synchronous transmission of multiple PPDUs (e,g., synchronous multi-link, multi-AP). FIG. 39 depicts a flow diagram 3900 illustrating an example A-PPDU sounding procedure in a multi-link (Link 1, Link 2) system according to an embodiment of the present disclosure. In this embodiment, synchronous transmission may contain multiple EHT PPDUs. More specifically, an AP 3902 simultaneously transmits two separate EHT DL PPDUs each carrying an EHT NDP Announcement frames, to initiate an aggregated TB sounding procedure across two links. One of the EHT NDP Announcement frames is targeted at EHT STAs in Link 1, whereas the other one of the EHT NDP Announcement frames is targeted at EHT STAs in Link 2. After a SIFS, the AP 3902 simultaneously transmits two EHT Sounding NDPs to non-AP STAs in the respective links. After a SIFS, the AP 3902 transmits two separate DL PPDUs, each carrying a BFRP Trigger frame, to STAs of different generation simultaneously to solicit Beamforming Report feedback from the STAs at both Link 1 and Link 2. After a SIFS, the solicited EHT STAs 3904, 3606 in response transmit TB PPDUs containing corresponding Beamforming Report feedback, i.e., EHT CBR/CQI frame, simultaneously to the AP 3902. Subsequently, the AP 3902/the non-AP STAs 3904, 3906 may transmit DL/UL A-PPDU containing an EHT PPDU in Link 1 and Link 2, respectively. Advantageously, it is not necessary to extend the STAs' capabilities to support reception of a wider bandwidth PPDU under this embodiment.

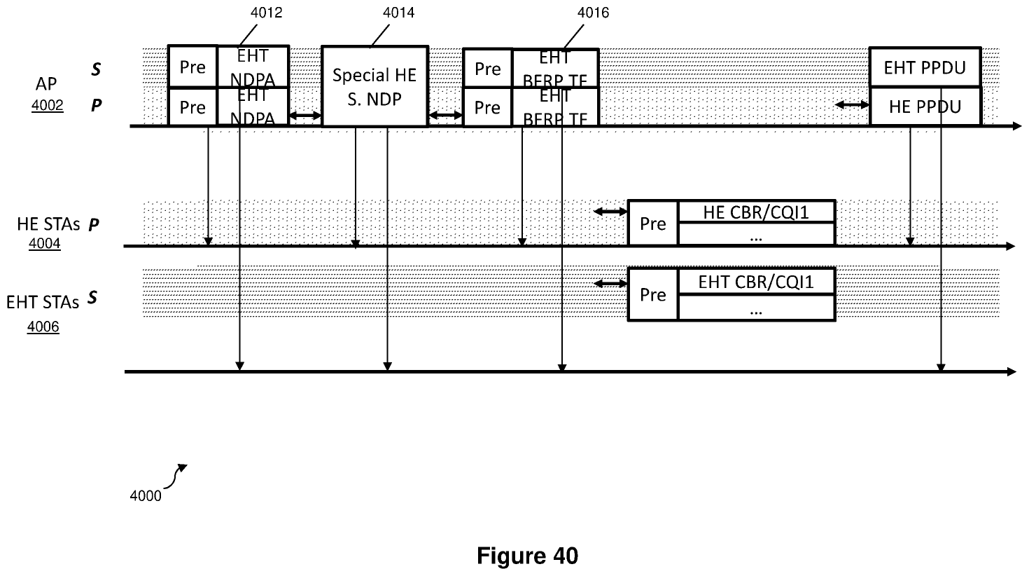

In another embodiment, the AP transmits a full bandwidth special HE Sounding NDP to both non-AP STAs of different generations. FIG. 40 depicts a flow diagram 4000 illustrating an example A-PPDU sounding procedure using full bandwidth special HE Sounding NDP 4014 according to an embodiment of the present disclosure. More specifically, an AP 4002 transmits a DL PPDU 4012 that carries EHT NDP Announcement frames to initiate an aggregated TB sounding procedure. The EHT NDP Announcement frame is targeted at both HE STAs and EHT STAs that are expected to transmit/receive an HE PPDU after the sounding procedure, and also at EHT STAs that are expected to transmit/receive an EHT PPDU after the sounding procedure. After a SIFS, the AP 4002 transmits the special HE Sounding NDP 4014 in full bandwidth including primary channel (P) and secondary channel(S) to non-AP STAs of different generations. After a SIFS, the AP 4002 transmits one or more DL PPDUs 3616 that carries EHT BFRP Trigger frames to HE STAs 4004 and EHT STAs 4006 simultaneously to solicit Beamforming Report feedback from the STAs. After a SIFS, the solicited HE STAs 4004 and the EHT STAs 4006 in response transmit TB PPDUs containing corresponding Beamforming Report feedback, i.e., HE CBR/CQI frame and EHT CBR/CQI frame, simultaneously to the AP 4002. Subsequently, the AP 4002/the non-AP STAs 4004, 4006 may transmit DL/UL A-PPDU containing an HE PPDU in the primary channel (P) and an EHT PPDU in the secondary channel(S), respectively.

The special HE Sounding NDP 4014 can be of 160 or 160+160 MHZ transmission. The bandwidth information of the preamble of the special HE Sounding NDP 4014 in the primary 160 MHz channel shall indicate 160 MHz transmission only, while the bandwidth information of the preamble of the special HE Sounding NDP 4014 in the secondary 160 MHZ channel may indicate 160+160 MHz transmission. The HE STAs 4004 receiving the HE Sounding NDP 4014 will treat it as a 160 MHz transmission, while the EHT STAs 4006 receiving the HE Sounding NDP 4014 will treat it as a 160+160 MHz transmission.

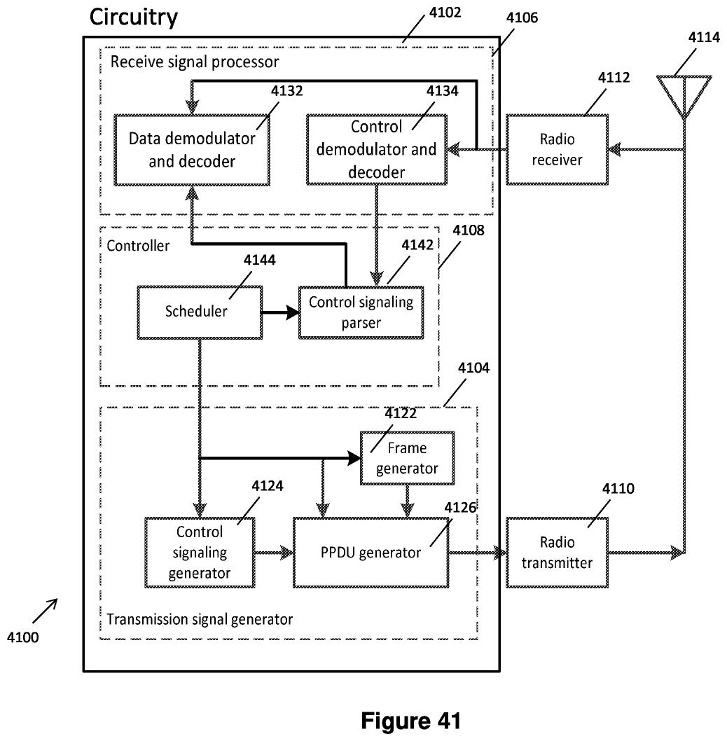

FIG. 41 depicts a configuration of a communication apparatus, for example an AP, according to various embodiments of the present disclosure. Similar to the schematic example of the communication apparatus 1800 shown in FIG. 18, the communication apparatus 4100 includes circuitry 4102, at least one radio transmitter 4110, at least one radio receiver 4112, at least one antenna 4114 (for the sake of simplicity, only one antenna is depicted in FIG. 41). The circuitry 4102 may include at least one controller 4108 for use in software and hardware aided execution of tasks that the controller 4108 is designed to perform communication for an aggregated signal sounding procedure. The circuitry 4102 may further include a transmission signal generator 4104 and a receive signal processor 4106. The at least one controller 4108 may control the transmission signal generator 4104 and the receive signal processor 4106. The transmission signal generator 4104 may include a frame generator 4122, a control signaling generator 4124, and a PPDU generator 4126. The frame generator 4122 may generate MAC frames, e.g., HE/EHT NDP Announcement frames, HE/EHT Sounding NDP, HE/EHT Special Sounding NDP or HE/EHT BFRP Trigger frames as described in various embodiments in the present disclosure. The control signaling generator 1824 may generate control signaling fields of PPDUs to be generated (e.g., HE/EHT-SIG fields of HE/EHT Sounding NDPs or HE/EHT-SIG fields of HE/EHT PPDUs comprising HE/EHT Sounding NDP, HE/EHT Special Sounding NDP or HE/EHT BFRP Trigger frames). The PPDU generator 4126 may generate PPDUs (e.g., HE/EHT Sounding NDPs, HE/EHT Special Sounding NDPs, HE/EHT PPDUs comprising HE/EHT Sounding NDP, HE/EHT Special Sounding NDP or HE/EHT BFRP Trigger frames).

The receive signal processor 4106 may include a data demodulator and decoder 4134, which may demodulate and decode data portions of the received signals (e.g., data fields of HE/EHT PPDUs comprising HE/EHT NDP Announcement frames, HE/EHT Sounding NDPs or EHT BFRP Trigger frames). The receive signal processor 4106 may further include a control demodulator and decoder 4134, which may demodulate and decode control signaling portions of the received signals (e.g., HE/EHT-SIG fields of HE/EHT Sounding NDPs or HE/EHT-SIG fields of HE/EHT PPDUs comprising HE/EHT Compressed Beamforming/CQI frames). The at least one controller 4108 may include a control signal parser 4142 and a scheduler 4144. The scheduler 4144 may determine RU information and user-specific allocation information for allocations of downlink SU or MU transmissions and triggering information for allocations of uplink MU transmissions. The control signal parser 4142 may analyse the control signaling portions of the received signals and the triggering information for allocations of uplink MU transmissions shared by the scheduler 4144 and assist the data demodulator and decoder 4132 in demodulating and decoding the data portions of the received signals (e.g., data fields of HE/EHT PPDUs comprising EHT Compressed Beamforming/CQI frames).

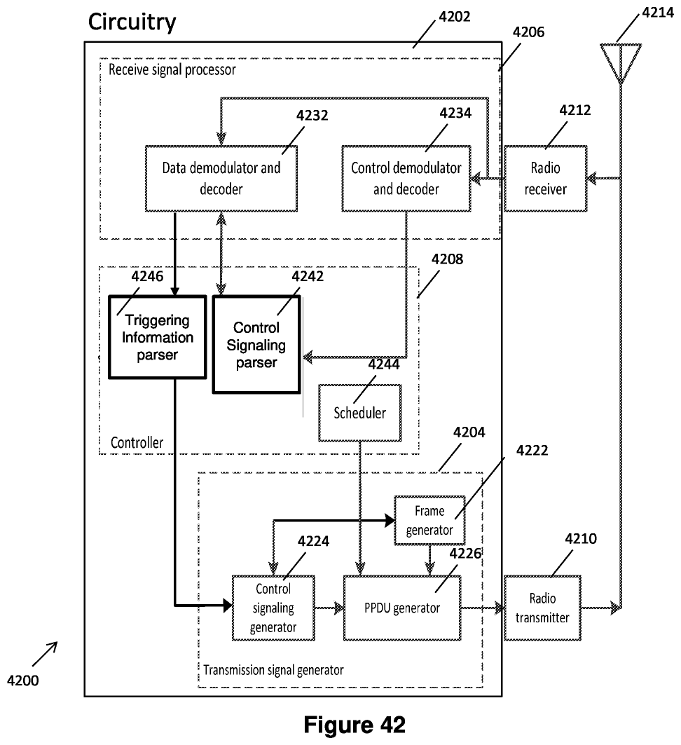

FIG. 42 depicts a configuration of a communication apparatus, for example a STA, according to various embodiments of the present disclosure. Similar to the schematic example of communication apparatus 1800 shown in FIG. 18, the communication apparatus 4200 includes circuitry 4202, at least one radio transmitter 4210, at least one radio receiver 4212, at least one antenna 4214 (for the sake of simplicity, only one antenna is depicted in FIG. 42). The circuitry 4202 may include at least one controller 1808 for use in software and hardware aided execution of tasks that the controller 4208 is designed to perform communication for an aggregated signal sounding procedure. The circuitry 4202 may further include a receive signal processor 4204 and a transmission signal generator 4206. The at least one controller 4208 may control the receive signal processor 4204 and the transmission signal generator 4206. The receive signal processor 4204 may include a data demodulator and decoder 4232 and a control demodulator and decoder 4234. The control demodulator and decoder 4234 may demodulate and decode control signaling portions of the received signals (e.g., HE/EHT-SIG fields of HE/EHT Sounding NDPs or HE/EHT-SIG fields of HE/EHT PPDUs comprising HE/EHT Sounding NDP, HE/EHT Special Sounding NDP or HE/EHT BFRP Trigger frames). The data demodulator and decoder 1032 may demodulate and decode data portions of the received signals (e.g., data fields of HE/EHT PPDUs comprising HE/EHT NDP Announcement frames, HE/EHT Sounding NDPs or EHT BFRP Trigger frames) according to RU information and user-specific allocation information of its own allocations.

The at least one controller 4208 may include a control signal parser 4242, and a scheduler 4244 and a trigger information parser 4246. The control signal parser 4242 may analyse the control signaling portions of the received signals (e.g. HE/EHT-SIG fields of HE/EHT Sounding NDPs or HE/EHT-SIG fields of HE/EHT PPDUs comprising HE/EHT Sounding NDP, HE/EHT Special Sounding NDP or HE/EHT BFRP Trigger frames) and assist the data demodulator and decoder 4232 in demodulating and decoding the data portions of the received signals (e.g., data fields of HE/EHT PPDUs comprising HE/EHT NDP Announcement frames, HE/EHT Sounding NDPs or EHT BFRP Trigger frames). The triggering information parser 4248 may analyse the triggering information for its own uplink allocations from the received triggering frames contained in the data portions of the received signals. The transmission signal generator 4204 may include a control signaling generator 4224, which may generate control signaling fields of PPDUs to be generated (e.g. HE/EHT-SIG fields of HE/EHT Sounding NDPs or HE/EHT-SIG fields of HE/EHT PPDUs comprising HE/EHT Compressed Beamforming/CQI frames). The transmission signal generator 4204 may further include a PPDU generator 4226, which generate PPDUs (e.g. HE/EHT PPDUs comprising HE/EHT NDP Announcement frames, HE/EHT Sounding NDPs or EHT BFRP Trigger frames). The transmission signal generator 4204 may further include a frame generator 4222 may generate MAC frames, e.g. EHT Compressed Beamforming/CQI frames.

As described above, the embodiments of the present disclosure provide an advanced communication system, communication methods and communication apparatuses for an aggregated signal sounding procedure in MIMO WLAN networks and improve spectral efficiency in MIMO WLAN networks.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

Some non-limiting examples of such a communication apparatus include a phone (e.g. cellular (cell) phone, smart phone), a tablet, a personal computer (PC) (e.g. laptop, desktop, netbook), a camera (e.g. digital still/video camera), a digital player (digital audio/video player), a wearable device (e.g. wearable camera, smart watch, tracking device), a game console, a digital book reader, a telehealth/telemedicine (remote health and medicine) device, and a vehicle providing communication functionality (e.g. automotive, airplane, ship), and various combinations thereof.

The communication apparatus is not limited to be portable or movable, and may also include any kind of apparatus, device or system being non-portable or stationary, such as a smart home device (e.g. an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

Table 4 illustrates starting and ending subcarrier indices corresponding to RU indices 1-36 for 4 groups (Ng=4) at 80 MHz channel

TABLE 4

| RU Index | 0 | 1 | 2 | 3 | 4 | 5 | 6 | 7 | 8 | 9 | 10 | 11 |
|---|---|---|---|---|---|---|---|---|---|---|---|---|
| Start | −500 | −476 | −448 | −420 | −392 | −368 | −340 | −312 | −288 | −260 | −232 | −204 |
| End | −472 | −448 | −420 | −392 | −364 | −340 | −312 | −284 | −260 | −232 | −204 | −176 |

| RU Index | 12 | 13 | 14 | 15 | 16 | 17 | 18 | 19 | 20 | 21 | 22 | 23 |
|---|---|---|---|---|---|---|---|---|---|---|---|---|
| Start | −180 | −152 | −124 | −100 | −72 | −44 | −16 | 16 | 44 | 72 | 96 | 124 |
| End | −152 | −124 | −96 | −72 | −44 | −16 | 16 | 44 | 72 | 100 | 124 | 152 |

| RU Index | 24 | 25 | 26 | 27 | 28 | 29 | 30 | 31 | 32 | 33 | 34 | 35 |
|---|---|---|---|---|---|---|---|---|---|---|---|---|
| Start | 152 | 176 | 204 | 232 | 260 | 284 | 312 | 340 | 364 | 392 | 420 | 448 |
| End | 180 | 204 | 232 | 260 | 288 | 312 | 340 | 368 | 392 | 420 | 448 | 476 |

| RU Index | 36 |
|---|---|
| 1Start | 472 |
| End | 500 |

Table 5 illustrates starting and ending subcarrier indices corresponding to RU indices 1-36 for 16 groups (Ng=16) at 80 MHz channel

TABLE 5

| RU Index | 0 | 1 | 2 | 3 | 4 | 5 | 6 | 7 | 8 | 9 | 10 | 11 |
|---|---|---|---|---|---|---|---|---|---|---|---|---|
| Start | −500 | −484 | −452 | −420 | −404 | −372 | −340 | −324 | −292 | −260 | −244 | −212 |
| End | −468 | −436 | −420 | −388 | −356 | −340 | −308 | −276 | −260 | −228 | −196 | −164 |

| RU Index | 12 | 13 | 14 | 15 | 16 | 17 | 18 | 19 | 20 | 21 | 22 | 23 |
|---|---|---|---|---|---|---|---|---|---|---|---|---|
| Start | −180 | −164 | −132 | −100 | −84 | −52 | −20 | 4 | 36 | 68 | 84 | 116 |
| End | −148 | −116 | −84 | −68 | −36 | −4 | 20 | 52 | 84 | 100 | 132 | 164 |

| RU Index | 24 | 25 | 26 | 27 | 28 | 29 | 30 | 31 | 32 | 33 | 34 | 35 | 36 |
|---|---|---|---|---|---|---|---|---|---|---|---|---|---|
| Start | 148 | 164 | 196 | 228 | 260 | 276 | 308 | 340 | 356 | 388 | 420 | 436 | 468 |
| End | 180 | 212 | 244 | 260 | 292 | 324 | 340 | 372 | 404 | 420 | 452 | 484 | 500 |

Table 6 illustrates starting and ending subcarrier indices corresponding to RU indices 1-73 for 4 groups (Ng=4) at 160 MHz channel

TABLE 6

| RU Index | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| Start | −1012 | −988 | −960 | −932 | −904 | −880 | −852 | −824 | −800 | −772 | −744 | −716 | −692 | −664 | −636 | −612 |
| End | −984 | −960 | −932 | −904 | −876 | −852 | −824 | −796 | −772 | −744 | −716 | −688 | −664 | −636 | −608 | −584 |

| RU Index | 16 | 17 | 18 | 19 | 20 | 21 | 22 | 23 | 24 | 25 | 26 | 27 | 28 | 29 | 30 | 31 |
|---|---|---|---|---|---|---|---|---|---|---|---|---|---|---|---|---|
| Start | −612 | −556 | −528 | −496 | −468 | −440 | −416 | −388 | −360 | −336 | −308 | −280 | −252 | −228 | −200 | −172 |
| End | −584 | −528 | −496 | −468 | −440 | −412 | −388 | −360 | −332 | −308 | −280 | −252 | −224 | −200 | −172 | −144 |

| RU Index | 32 | 33 | 34 | 35 | 36 | 37 | 38 | 39 | 40 | 41 | 42 | 43 | 44 | 45 | 46 | 47 |
|---|---|---|---|---|---|---|---|---|---|---|---|---|---|---|---|---|
| Start | −148 | −120 | −92 | −64 | −40 | 12 | 36 | 64 | 92 | 120 | 144 | 172 | 200 | 224 | 252 | 280 |
| End | −120 | −92 | −64 | −36 | −12 | 40 | 64 | 92 | 120 | 148 | 172 | 200 | 228 | 252 | 280 | 308 |

| RU Index | 48 | 49 | 50 | 51 | 52 | 53 | 54 | 55 | 56 | 57 | 58 | 59 | 60 | 61 | 62 | 63 |
|---|---|---|---|---|---|---|---|---|---|---|---|---|---|---|---|---|
| Start | 308 | 332 | 360 | 388 | 412 | 440 | 468 | 496 | 528 | 556 | 584 | 608 | 636 | 664 | 688 | 716 |
| End | 336 | 360 | 388 | 416 | 440 | 468 | 496 | 528 | 556 | 584 | 612 | 636 | 664 | 692 | 716 | 744 |

| RU Index | 64 | 65 | 66 | 67 | 68 | 69 | 70 | 71 | 72 | 73 |
|---|---|---|---|---|---|---|---|---|---|---|
| Start | 744 | 772 | 796 | 824 | 852 | 876 | 904 | 932 | 960 | 984 |
| End | 772 | 800 | 824 | 852 | 880 | 904 | 932 | 960 | 988 | 1012 |

Table 7 illustrates starting and ending subcarrier indices corresponding to RU indices 1-73 for 16 groups (Ng=16) at 160 MHz channel

TABLE 7

| RU Index | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| Start | −1012 | −996 | −964 | −932 | −916 | −884 | −852 | −836 | −804 | −772 | −756 | −724 | −692 | −676 | −644 | −612 |
| End | −980 | −948 | −932 | −900 | −868 | −852 | −820 | −788 | −772 | −740 | −708 | −676 | −660 | −628 | −596 | −580 |

| RU Index | 16 | 17 | 18 | 19 | 20 | 21 | 22 | 23 | 24 | 25 | 26 | 27 | 28 | 29 | 30 | 31 |
|---|---|---|---|---|---|---|---|---|---|---|---|---|---|---|---|---|
| Start | −596 | −564 | −532 | −508 | −476 | −444 | −428 | −396 | −364 | −348 | −316 | −284 | −252 | −236 | −204 | −172 |
| End | −548 | −516 | −492 | −460 | −428 | −412 | −380 | −348 | −332 | −300 | −268 | −252 | −220 | −188 | −172 | −140 |

| RU Index | 32 | 33 | 34 | 35 | 36 | 37 | 38 | 39 | 40 | 41 | 42 | 43 | 44 | 45 | 46 | 47 |
|---|---|---|---|---|---|---|---|---|---|---|---|---|---|---|---|---|
| Start | −156 | −124 | −92 | −76 | −44 | 12 | 28 | 60 | 92 | 108 | 140 | 172 | 188 | 220 | 252 | 268 |
| End | −108 | −92 | −60 | −28 | −12 | 44 | 76 | 92 | 124 | 156 | 172 | 204 | 236 | 252 | 284 | 316 |

| RU Index | 48 | 49 | 50 | 51 | 52 | 53 | 54 | 55 | 56 | 57 | 58 | 59 | 60 | 61 | 62 | 63 |
|---|---|---|---|---|---|---|---|---|---|---|---|---|---|---|---|---|
| Start | 300 | 332 | 348 | 380 | 412 | 428 | 460 | 492 | 516 | 548 | 580 | 596 | 628 | 660 | 676 | 708 |
| End | 348 | 364 | 396 | 428 | 444 | 476 | 508 | 532 | 564 | 596 | 612 | 644 | 676 | 692 | 724 | 756 |

| RU Index | 64 | 65 | 66 | 67 | 68 | 69 | 70 | 71 | 72 | 73 |
|---|---|---|---|---|---|---|---|---|---|---|
| Start | 740 | 772 | 788 | 820 | 852 | 868 | 900 | 932 | 948 | 980 |
| End | 772 | 804 | 836 | 852 | 884 | 916 | 932 | 964 | 996 | 1012 |

1. A communication apparatus comprising:
circuitry, which, in operation, generates at least one signal, wherein a part of the at least one signal is configured for a first station of a first generation and another part of the at least one signal is configured for a second station of a second generation in a sounding procedure; and
a transmitter, which, in operation, transmits the at least one signal.

2. The communication apparatus of claim 1, wherein at least a part of the at least one signal includes information for the second station, and the first station does not recognize the information.

3. The communication apparatus of claim 1, wherein
the at least one signal comprises a first signal, a second signal and a third signal, wherein the first signal indicates a sounding sequence of the sounding procedure, the second signal carries a field for channel estimation, the third signal carries information to solicit a response signal, and at least one of the first signal and the second signal is configured for the first station of the first generation; and
the transmitter, which, in operation, transmits the first signal, the second signal and the third signal to the second station of the second generation to solicit the response signal from the second station before the transmitter transmits data to the second station.

4. The communication apparatus of claim 3, wherein both the first signal and the second signal are configured for the first station, and the response signal and the data are configured for the second station.

5. The communication apparatus of claim 3, wherein the first signal, the second signal and the response signal are configured for the first station, and the data are configured for the second station.

6. The communication apparatus of claim 3, wherein the first signal, the response signal and the data are configured for the second station.

7. The communication apparatus of claim 5, wherein the transmitter transmits the first signal to the second station only in a secondary channel to signal the transmission of the second signal and the third signal in the secondary channel.

8. The communication apparatus of claim 5, wherein the first signal comprises a signal field, wherein at least a part of the signal field signals the transmission of the second signal and the third signal.

9. The communication apparatus of claim 5, wherein the first signal comprises a bandwidth information field signaling a pair of resource unit indices having a RU size larger than 26-tone, the pair of resource unit indices relating to a plurality of subcarriers for which the response signal is solicited.

10. The communication apparatus of claim 6, wherein the transmitter further transmits the first signal, the second signal and the third signal to a third station of the second generation to solicit a second response signal from the third station, simultaneously with the transmission of the first signal, the second signal and the third signal to the second station, before the transmitter transmits second data to the third station.

11. The communication apparatus of claim 3, wherein both the first signal and the second signal are configured for the second station, the first signal comprising a first signal field signaling an absence of a second signal field in the second signal, and the circuitry is configured to generate the second signal without the second signal field.

12. The communication apparatus of claim 3, wherein the first signal, the second signal and third signal are configured for the second station, and the at least one signal further comprises a fourth signal, a fifth signal and a sixth signal configured for the first station, and wherein the fourth signal indicates a second sounding sequence of the sounding procedure, the fifth signal carries a second field for channel estimation, the sixth signal carries information to solicit a second response signal, and the transmitter further transmits the fourth signal, fifth signal and sixth signal to the first station to solicit a second response signal from the first station, simultaneously with the transmission of the first signal, the second signal and the third signal to the second station, before the transmitter transmits second data to the first station.

13. The communication apparatus of claim 3, wherein both the first signal and the third signal are configured for the second station, and the at least one signal further comprises a fourth signal and a fifth signal configured for the second station, and wherein the fourth signal indicates the sounding sequence of the sounding procedure the fifth signal carries information to solicit a second response signal, and the transmitter further simultaneously transmits the fourth signal to the first station and the first signal to the second station, the second signal to both the first station and second station, and then the fifth signal to the first station and the third signal to the second station to solicit the second response signal and the response signal, respectively, before the transmitter transmits second data to the first station and the data to the second station.

14. A communication method implemented by a communication apparatus comprising:
generating at least one signal, wherein a part of the at least one signal is configured for a first station of a first generation and another part of the at least one signal is configured for a second station of a second generation in a sounding procedure; and
transmitting the at least one signal.

15. A first station comprising;
A receiver, which, in operation, receive at least one signal, wherein a part of the at least one signal is configured for the first station of a first generation and another part of the at least one signal is configured for a second station of a second generation in a sounding procedure; and
circuitry, which, in operation, decodes the at least one signal.

16. A communication method implemented by a first station comprising:
receiving at least one signal, wherein a part of the at least one signal is configured for the first station of a first generation and another part of the at least one signal is configured for a second station of a second generation in a sounding procedure; and
decoding the at least one signal.
